(19) United States
(12) Patent Application Publication
(10) Pub. No.: US 2019/0285220 A1
(43) Pub. Date: Sep. 19, 2019

(54) Device For Reducing Pressure Surge

(71) Applicants: Gyula Eros, Szigethalom (HU); Dora Bereznai, Budapest (HU); Jozsef Bereznai, Budapest (HU)

(72) Inventors: Gyula Eros, Szigethalom (HU); Dora Bereznai, Budapest (HU); Jozsef Bereznai, Budapest (HU)

(21) Appl. No.: 16/302,397

(22) PCT Filed: May 18, 2016
(86) PCT No.: PCT/HU2017/000033

§ 371 Date: Nov. 16, 2018

(30) Foreign Application Priority Data
May 19, 2016 (HU) P1600326

(51) Int. Cl. F16L 55/053

(52) U.S. Cl. CPC F16L 55/053

(57) ABSTRACT

The invention is a device for reducing pressure surge, comprising a container having an inner space which container has a connection opening (28) for connecting a pipe member being suitable for flowing fluid, a piston member (14) dividing the inner space of the container into a fluid space (20) being in fluid flow connection with the connection opening (28) and a gas space (30), and being movable along a piston displacement axis, an elastic element being arranged in the gas space (30), being supported against the piston member (14) and undergoing elastic deformation in case the piston member (14) is displaced along the piston displacement axis, and a throttle valve (60) being in fluid flow connection with the gas space (30) at any position of the piston member (14), being arranged to connect the gas space (30) and the space surrounding the container, and allowing a continuous gas flow in both directions.

### TECHNICAL FIELD

The invention relates to a device adapted for reducing (managing) pressure surge (pressure blow, especially, network or closure pressure surge, e.g. water hammer). Network pressure surge is essentially a shock wave produced for some reason, especially by an abrupt interruption of flow somewhere in a network carrying a fluid (a liquid or gaseous material), generated by the inertia of the accelerated fluid (a load produced by pressure surge generated by other devices in the network) which travels through at least a part of the fluid network. A shock wave accompanies also closure (closing) pressure surge that can be produced by (abruptly) interrupting consumption flow at a given point of consumption in a fluid network, e.g. by turning off a tap, this phenomenon therefore corresponds to a given appliance. Network- and closure pressure surges are therefore related phenomena as both are associated with an abrupt closure. They can be differentiated by whether the effect on the entire network or on a given closable device is analysed; but due to the incompressibility of the liquid they correspond to the same overpressure event.

### BACKGROUND ART

A pressure surge is disadvantageously produced—especially at relatively higher network pressures—when certain tap cartridge types, e.g. ceramic-cartouche universal single-lever mixer tap cartridges are turned off with a sudden movement, which places a technical load not only on the given tap cartridge but also on the pipe network, and significantly increases the risk of failure for devices connected to the network. Pressure surge may occur not only in liquid (pipe) networks (water hammer, liquid hammer) but also in other fluid (pipe) networks (fluid hammer), such as in gas pipe networks.

In addition to the above mentioned problems fluid hammer may cause oscillations in the pipe system of the fluid network, which—especially with lightweight-construction walls—may result in disturbing noise even at locations and levels significantly further away from the given consumer. The phenomenon may occur in fluid networks, such as liquid (typically water) and gas networks.

In U.S. Pat. No. 9,284,965 B2 a device with flow-through arrangement for reducing pressure surge (water hammer or fluid hammer arrester, -suppressor, pressure spike damper device). The device according to the document comprises a container divided by a piston into a liquid space and a closed gas space. The liquid space is in connection with the flowing liquid; by displacing the piston the flowing liquid is capable of increasing the volume of the liquid space at the expense of the gas space in case such a pressure rise is produced that is large enough to displace the piston against the pressure of the overpressurized gas space. Fluid hammer is reduced by this known device in the above described manner. In the known approach, chambers are arranged at the end of the gas space situated opposite the piston for receiving gas in the event when the piston is displaced to its terminal position defined by the geometry of the components.

The drawback of this known solution is that as a result of the fluid hammer events pressure in the already highly pressurized gas space increases further, and thus the seals of the gas space (which isolate the gas space from the fluid space) are subjected to high stresses. This results in that the device for reducing pressure surge according to the document is worn over time and its efficiency is reduced (compared to its original condition, i.e. it can no longer suppress pressure surge to the original extent by the reduction of the pressure of the gas space, and is no longer capable of leading back the piston after the pressure rise accompanying the pressure surge is over, it may even happen over time that the piston can no longer assume its base position).

A further device for reducing pressure surge is disclosed in EP 0430223 A1. In the approach according to the document a container comprising a piston and being divided into a gas space and a fluid space connected to the network is applied for reducing the pressure surge. In the event of a pressure surge the fluid space of the container with a piston can expand against the spring arranged in the gas space. In the approach the network fluid passes through a Venturi pipe that is connected to the above mentioned fluid space via low-cross section passages.

In EP 0430223 A1 a variant is disclosed wherein the gas space is put in communication with the space surrounding the container via a passage. Accordingly, the back-and-forth flow between the gas space and the outside space is uncontrolled. The application of a passage having such a configuration also has the following disadvantage. Air can be discharged freely from the gas space, and so the expansion of the liquid space resulting from the pressure surge is essentially countered only by the spring arranged in the gas space; this makes it necessary to include a spring with a relatively high spring constant.

Variants having an opposite purpose are also disclosed in EP 0430223 A1. In these variants the gas space and the outside space are connected via check valves of various configurations. The purpose of these embodiments is that in the event of outflow the check valve (that is shut off in case of outflow) inhibits outflow from the gas space such that in case the seals between the liquid space and the gas space fail, leaked-through liquid is prevented from being discharged from the gas space. Additionally, the resistance of the closed gas space thus produced is combined with the counterforce provided by the piston in the event of the reduction of gas space volume. When the pressure surge event is over, the volume of the gas space starts to increase again and the check valve opens. The purpose of the variants comprising check valve is, in the event of a potential leakage, to prevent liquid entering the gas space from being discharged therefrom. In order to this, in certain variants with check valve, the check valve is also provided with a spring adapted for assisting in bringing the valve into its closed state and maintaining that state, i.e. the appropriate closure thereof (thanks to the arrangement of the spring the check valve returns into its closed state if there is no inflow). To achieve this objective, in this known approach check valves of the highest quality, i.e. providing the most perfect closure possible have to be applied.

Devices for reducing fluid hammer comprising a piston and a spring that is disposed in the gas space and is adapted for counteracting the volume reduction thereof are disclosed also in GB 762,197, JPH 05126292 A, and GB 2,104,595 A.

In view of the known approaches, there is a demand for a device for reducing pressure surge that is capable of performing its function long lasting, with an enduring effectiveness.

### DESCRIPTION OF THE INVENTION

The primary object of the invention is to provide a device for reducing pressure surge, which is free of disadvantages of prior art approaches to the greatest possible extent.

The object of the invention is to provide a device for reducing pressure surge that is capable of performing its function long lasting, with an enduring effectiveness. A further object is to provide a device wherein the sealing members isolating the gas space are subjected to the lowest load possible, preferably to provide a device wherein the inherent leakage of the sealing members does not pose a problem for the operation of the device for reducing fluid hammer.

By means of the device according to the invention for reducing pressure surge, particularly for reducing or damping the shock wave accompanying the pressure surge event the above objects can be achieved and the disadvantages of known approaches can be eliminated.

The device for reducing pressure surge according to the invention (which may also be called a pressure reducing device or a pressure surge reducing device) is of course size-independent because it can be utilized for all such applications where there is a need for reducing pressure surge associated with the rapid closure of taps, valves and other similar mechanisms.

In the case of the device for reducing pressure surge according to the invention that utilizing a piston member for isolating a network-connectible fluid space from a gas space, the back and forth (bidirectional) flow between the gas space and the outside space is controlled thanks to the inclusion of a throttle valve. Thanks to the arrangement and configuration of the throttle valve a continuous outflow is provided—in the event when the volume of the gas space is decreased—from the gas space of the device according to the invention to ensure that the fluid possibly leaking from the fluid space into the gas space is discharged. Besides that, the throttle valve provides a greater inflow rate compared to the outflow rate for the case when the volume of the gas space is increasing. Due to throttling, therefore, discharging of the gas space is slower compared to its charging, so the gas present in the gas space in a slowly decreasing amount contributes to the counterforce exerted by the elastic element on the piston member.

The application of the device for reducing pressure surge according to the invention provides the advantage that it is not required to modify or adapt existing appliances (consumers); in an embodiment, the device according to the invention has to be connected in series into the fluid system (i.e. has to be inserted into the pipe carrying the fluid flow) subjected to a danger of pressure surge; due to the inclusion (insertion) of the device fluid hammer can be reduced significantly. Some embodiments of the device according to the invention are to be connected to the fluid system in parallel (via a single connection, in which case the device is inserted into the system by means of a T- or Y-member, or is connected to an end point of the network), the efficiency of parallel-connected devices can be slightly lower relative to series-connected devices.

The objects of the invention can be achieved by the device for reducing pressure surge according to claim 1. Preferred embodiments of the invention are defined in the dependent claims.

### BRIEF DESCRIPTION OF THE DRAWINGS

Preferred embodiments of the invention are described below by way of example with reference to the following drawings, where

FIG. 1 is the sectional drawing of an embodiment of the device according to the invention, illustrating the piston member in an intermediate state (flow-through embodiment),

FIG. 2 shows the embodiment of FIG. 1, illustrating the piston member in its maximum-displacement position,

FIG. 3 is a sectional drawing of an example illustrating the piston member in its base position,

FIG. 4 is a drawing illustrating the cap element in underside view,

FIG. 5 is a schematic side view illustrating exemplary arrangement options of the flow-through embodiments of the device according to the invention,

FIG. 6 is a sectional drawing of a single-connection embodiment (an embodiment having a single connection opening) of the device according to the invention,

FIG. 7 is a sectional drawing of a further single-connection embodiment of the device according to the invention,

FIG. 8 is a sectional drawing of a still further single-connection embodiment of the device according to the invention,

FIG. 9 is a magnified drawing of an embodiment of the throttle valve,

FIG. 10 is a sectional drawing of a still further embodiment of the invention (comprising a further throttle valve variant), depicting the device connected to a pipe member,

FIG. 11 is a magnified sectional drawing showing the throttle valve of FIG. 10,

FIG. 12 is a sectional drawing of a single-connection embodiment of the invention, showing the device connected to a pipe member,

FIG. 13 is a sectional drawing showing a single-connection embodiment of the invention connected to a pipe member,

FIG. 14 is a sectional drawing of a dual-connection embodiment (an embodiment having two connection openings) of the invention, with one of the inlets being closed,

FIG. 15 is a sectional drawing of an embodiment of the device according to the invention showing the device connected to a pipe member,

FIG. 16 is a sectional drawing of a further embodiment of the invention,

FIG. 17 is a sectional drawing of a further example,

FIG. 18 is a spatial sectional drawing of the embodiment shown in FIG. 8,

FIG. 19 is a spatial sectional drawing of an embodiment that is very similar to the one shown in FIG. 3,

FIG. 20 is a sectional drawing of a further embodiment of the device according to the invention,

FIG. 21 is a spatial sectional drawing of the embodiment of FIG. 20,

FIG. 22 is a sectional drawing of a further embodiment of the device according to the invention,

FIG. 23 is a spatial sectional drawing of the embodiment of FIG. 22,

FIGS. 24A and 24B are spatial sectional drawings showing a further embodiment of the invention, illustrating the two terminal positions of the piston member,

FIGS. 25A and 25B are detail drawings illustrating the throttle valve of the embodiment shown in FIGS. 24A and 24B showing the two terminal positions of the moving member,

FIG. 26A is a spatial drawing illustrating the moving member shown in FIGS. 24A-25B,

FIG. 26B shows the embodiment of FIGS. 24A-25B in a section cutting through the throttle valve,

FIG. 27A illustrates a further exemplary embodiment of the moving member,

FIG. 27B is a sectional drawing illustrating the moving member shown in FIG. 27A in a section corresponding to FIG. 26B,

FIG. 28 is a spatial drawing illustrating an embodiment of the device according to the invention, and

FIGS. 29A and 29B are sectional drawings illustrating the flow conditions in the throttle valve in an embodiment of the invention, showing the moving member in positions during fluid inflow and outflow.

### MODES FOR CARRYING OUT THE INVENTION

The device for reducing pressure surge according to the invention comprises a container (tank) having an inner space, the container has a connection opening for connecting a pipe member (tube member) being suitable for flowing fluid. It further comprises a piston member separating (dividing) the inner space of the container into a fluid space being in fluid flow connection (fluid communication) with the connection opening and a gas space, and being movable along a piston displacement axis, and an elastic element being arranged in the gas space, being supported against (abutting to) the piston member and undergoing elastic deformation (subjected to elastic deformation, i.e. elastic expansion or compression) in case the piston member is displaced along the piston displacement axis.

The device according to the invention further comprises a throttle valve being in fluid flow connection (in fluid flow communication, communicating connection, therefore in gas communication) with the gas space at any position (any displacement) of the piston member, being arranged to connect the gas space and the space surrounding the container (i.e. to connect these), having a first gas flow resistance in case gas flows into the gas space and a second gas flow resistance being larger than the first gas flow resistance in case (i.e. for the case, when) gas flows out of the gas space, and allowing a continuous gas flow in both directions (the throttle valve being configured for providing continuous gas flow-through during gas inflow and outflow—i.e. during the volume-expansion and volume-contraction of the gas space). The throttle valve applied according to the invention can therefore also be called a bidirectional throttle valve.

By the phrasing “the throttle valve is in fluid flow connection with the gas space” it is meant that the outlet of the throttle valve proximate the gas space is in connection with the gas space independent of the position of the piston member. Our experiments have indicated that it is expedient to configure the throttle valve such that the flow rate (the mass of fluid passing through the throttle valve per unit time) of inflow is 3-100 times, preferably 10-100 times, particularly preferably 15-25 times the flow rate of the outflow.

Some embodiments of the throttle valves applicable according to the invention are explained in detail below. As also illustrated later on—as with the throttle passage it typically formed with—the throttle valve is in fluid flow connection (e.g. gas flow connection) with the gas space upon any displacement of the piston member, and is arranged to connect the gas space and the space surrounding the container.

The main differences between the throttle valve applied according to the invention and the check valve applied according to the known approach are the following: The role of the check valve is to block the flow in one direction. The check valve applied in the known approach blocks the flow when the volume of the gas space decreases, i.e. it prevents the outflow of the content of the gas space. Since the object of the conventional solution is to prevent fluid that may have leaked from the fluid space from flowing out of the gas space, the check valve has to provide as perfect close as possible, and has to be configured accordingly.

In contrast to that, due to its configuration the throttle valve lets through fluid flow in both directions, i.e. it is configured to provide bidirectional continuous flow (at all times (always), i.e. independent of the position of the components (subassemblies) of the valve structure responsible for operating the valve (i.e. typically, a moving member)), and therefore upon decreasing of the volume of the gas space it allows the outflow of gas, and in the case of a volume increase of the gas space it allows the inflow of gas.

An important component of the device for reducing pressure surge is the container. A container wherein the fluid space is bounded by a piston member such that the volume of the fluid space can be changed as a result of a pressure surge (i.e. the piston member can be displaced) is connected via the connection opening of the container to the fluid space of the pipe member adapted for carrying a fluid flow. Under the effect of a pressure increase resulting from a pressure surge propagating in the flowing fluid, the fluid space therefore undergoes expansion by displacing the piston member, thereby reducing pressure surge, i.e. damping the shock wave corresponding to the pressure surge.

Preferably, a connection member is arranged on the connection opening in order that the pipe member (e.g. a pipe member of a (water) network) can be connected through it, however, the pipe member can be connected to the connection opening in other way providing that the fluid connection (fluid flow connection) between the network pipe member and the fluid space is ensured. By a fluid connection it is meant that the fluid flowing in through the connection opening can enter the fluid space; i.e. that the connection opening and the fluid space are in communication. The fluid space can also be called the first spatial region or primary space, while the gas space can also be called the second spatial region or secondary space. The piston displacement axis is an (imaginary) axis that is not physically present and, as it is illustrated in the figures, extends along the centreline of the device.

The piston member is configured as a conventional piston: it divides the space wherein it is arranged into two parts and can only be displaced along a piston displacement axis; it cannot be displaced in a cross direction to this axis because it is supported against the container wall. The inner space of the container is divided by the piston member into a fluid space and a gas space, so when the piston member is displaced in one direction, the volume of the fluid space increases at the expense of the gas space (the volume of the gas space may be reduced to a very low volume; in the case of an open gas space, i.e. no gas is required to remain in the gas space, it can be lowered to zero volume), while in the case where the piston member is displaced in the other direction the volume of the gas space increases at the expense of the fluid space (depending on the configuration of the fluid space and on the base position of the piston member in this case the volume of the fluid space can also be reduced to a very low value, such an embodiment is conceivable wherein this very low volume is essentially zero, disregarding of course the passages leading into the fluid space, i.e. the optionally included conduction channel and the fluid transfer allowing openings).

An elastic element is arranged in the gas space (thus the gas space is also the torsion space of the elastic element; the elastic element is arranged between the piston member and the portion of the container that is situated opposite the end of the piston member facing the gas space (inserted there); the elastic element is thus supported (abuts) against these portions of the piston member and the container), the elastic element thereby undergoing elastic deformation when the piston member is displaced along the piston displacement axis (i.e. in the only possible displacement direction of the piston member). Since the elastic element is arranged in the gas space, it undergoes elastic compression relative to a given piston element position when the volume of the gas space decreases due to the displacement of the piston member, and conversely, the elastic element undergoes elastic expansion (with respect to its compressed state) when the volume of the gas space increases as a result of the displacement of the piston member. This compression and elongation will be demonstrated below in an embodiment of the invention wherein the elastic element is a spring.

Thus, in the device for reducing pressure surge according to the invention an elastic element (elastic energy storing element or force storage element, preferably a spring) is applied. It is preferable to apply an elastic element because the elastic constant thereof can be chosen to correspond to the foreseeable magnitude of pressure surge events, and thereby the operation of the device can be kept under control by adjusting mechanical parameters. The elastic constant is preferably chosen such that the piston member is kept at or near its base position in case a pressure surge is not present. Provided that it is dimensioned appropriately, the device according to the invention is capable of effectively reducing pressure surge in all pressure ranges. In the case of communal water networks harmful pressure surge events result in pressures over approx. 3 bar. In the event of a pressure surge with a pressure above 5 bar the device according to the invention can provide especially effective damage prevention because during a pressure surge event pressures many times as high as the base pressure can occur. Applying the device according to the invention pressure surges can be reduced by half, or even to a tenth of their original value.

The elastic element has to be dimensioned such that it is fully compressed at approximately the largest foreseen pressure surge pressure value (e.g., the spring 16 is retracted in the receptive opening 38 at this pressure value). When dimensioning the elastic element, the gas flow resistance of the throttle valve (and of the throttle opening and throttle passage that are also typically included) also has to be taken into account. Typically, a distinction is made between low-pressure systems with a base pressure of approximately 1.5 bar and high-pressure systems with a pressure around 10 bar, so the devices usually have to be dimensioned for these two system types.

Another advantage of applying an elastic element is that it removes the need to include high-pressure gas in the gas space in those examples wherein the gas space is closed. The reason for that is that the displacement of the piston member resulting from a pressure surge is slowed down (damped) primarily by the elastic element, and the piston member is returned to its normal state (the state wherein the shock wave accompanying the pressure surge has passed or has not yet arrived; the condition that normally—i.e. in case of a normal, shock wave-free flow—prevails in the pipe member adapted to be connected to the device according to the invention), to the so-called base state by the elastic element thanks to the energy stored therein. The piston member can therefore be moved preferably between two end points (the base position and the position with largest displacement). The elastic element is arranged in a biased state such that it can urge the piston member towards is base position. Whether the piston member can assume its base position after the pressure surge event is over depends on the normal pressure of the flowing fluid (in the absence of a pressure surge) and on the dimensioning of the elastic element; if, for example, the elastic constant of the elastic element is slightly lower than would be expected and the normal pressure is slightly higher than expected, a “rest displacement” may occur (where the pressure of the fluid space counterbalances the elastic element) instead of returning of the piston member into its based position in a normal-pressure situation.

The elastic element (e.g. a spring) is thus disposed in the gas space and counteracts the pressure exerted by the fluid in the fluid space. The piston member, together with its appropriately arranged sealing member (or members), are moved by the elastic element as governed by force conditions. As a result of the displacement of the piston member the volume of the gas space increases or decreases, while the pressure of the gas space also changes. The degree and rate of pressure change in the gas space also depends on whether a throttle opening (pressure-balancing opening) or a throttle passage (throttle bore, pressurebalancing passage, channel or bore) connected to the gas space is arranged in addition to the throttle valve adapted for letting through fluid in both directions.

In the device according to the invention the piston member is displaced as a function of the pressure present in the fluid space and the gas space; it is urged towards its base position (where the elastic element is at the maximum expansion, i.e. where it stops) by the compressed elastic element when allowed by the pressure conditions of the fluid space and the gas space.

In an example helping the understanding of the invention the gas space can be closed (such an example is illustrated in FIG. 17), however, according to the invention the gas space has an open configuration, e.g. due to the inclusion of the throttle opening. As will be shown below, a throttle opening can preferably be arranged in gas flow connection with the gas space, the application of such an opening having a number of advantages. If a throttle opening is included the gas space is not closed: upon a given displacement of the piston member the gas (typically air) is pushed out of the gas space, while during the opposite-direction motion of the piston member towards its base position the gas space is refilled with air.

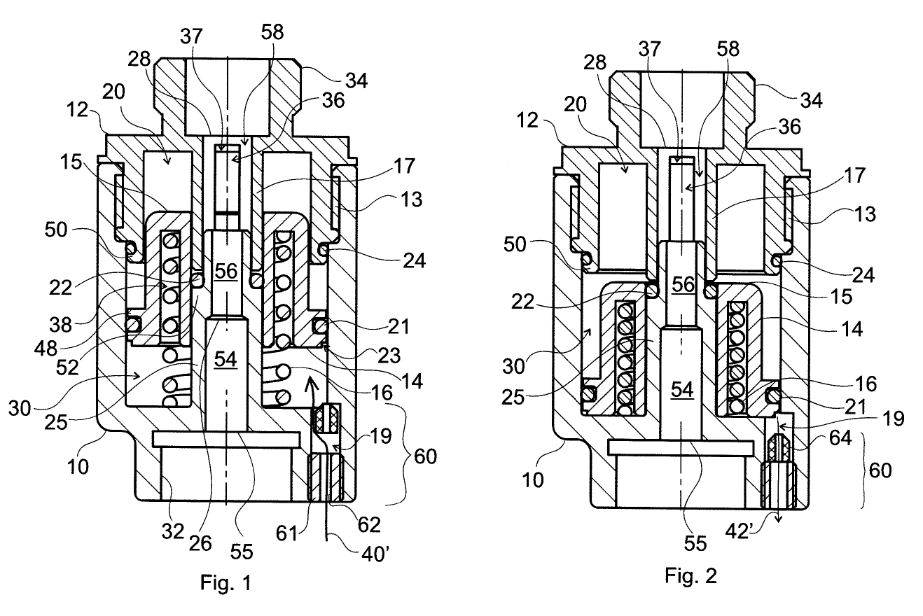

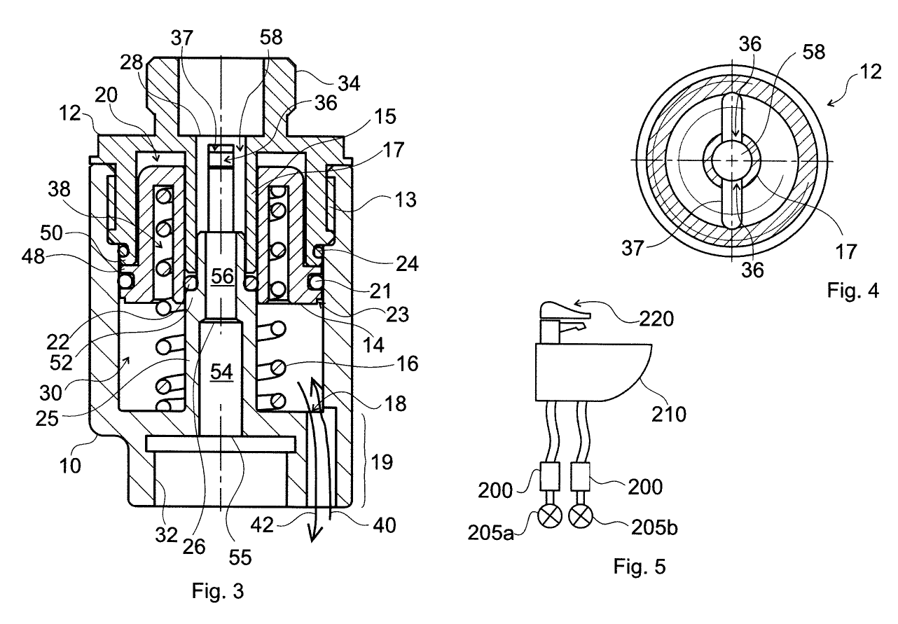

In FIG. 1 such an embodiment is illustrated wherein the container comprises a throttle opening 18 (a pressure balancing cut-out or other small-sized material shortage). In this embodiment the device according to the invention comprises a piston member 14 dividing the inner space of the container into a fluid space 20 (a liquid space if a liquid is applied) and a gas space 30. In the case shown in FIG. 1 the volume of the fluid space 20 is essentially the same as the volume of the gas space 30 (however, in the case of FIG. 2 and in the example of FIG. 3 the volumes of the spaces are significantly different, in favour of the fluid space 20, and of the gas space 30, respectively). In the present embodiment the container is provided with a connection opening 28 and the elastic element is implemented as a spring 16. In accordance with the arrangement of the elastic element the device according to the invention is a force-storage (energy-storage) device adapted for reducing pressure surge.

Thus, in this embodiment the invention comprises a throttle opening 18 being in gas flow connection with the gas space 30 at an arbitrary displacement (even zero displacement, full displacement, or an intermediate-degree displacement) of the piston member 14, opening from the gas space 30 into the space surrounding the container, and constituting a gas flow resistance. The instantaneous pressure inside the gas space is affected by the gas flow resistance of the throttle opening 18 (and the throttle passage, as well as the throttle valve). By arranging a throttle opening constituting a gas flow resistance and similarly by arranging a throttle passage and a throttle valve, gas outflow from the gas space can be delayed, the pressure increase due to the obstructed gas outflow is combined with the elastic force of the elastic element (e.g. with the spring force of a spring), i.e. allows to apply an elastic element with a relatively lower elastic constant (e.g. a spring with a relatively low spring constant), i.e. it is not necessary to over-engineer the elastic element. e.g. a spring. This consideration is also important from the aspect of the economic use of materials.

Thus, the throttle opening 18 is arranged such that it remains in gas flow connection with the gas space 30 in the case of any position or displacement of the piston member 14, i.e. the gas flowing in through the throttle opening 18 is capable of entering the gas space 30 (e.g. that the piston member does not pass beside it terminating the gas flow connection).

The throttle opening 18 constitutes a gas flow resistance, by which it is meant that it is dimensioned so as to constitute a resistance (i.e. that it allows outflow but has a given resistance in the flow). Accordingly, the cross section of the throttle opening is preferably between approximately 1/100 (typically those cases fall near this limit wherein only a throttle opening and a throttle passage is included without a throttle valve) and 1/100000 (typically those cases fall near this limit wherein a throttle valve is also included) of the surface of the piston member facing the gas space, the ratio preferably being 1/10000. The device of course works with dimensions different than that but with a different efficiency. The above ratio holds true over a relatively wide container size range, but the characteristic dimension of the throttle opening (its effective diameter; calculated from its cross section applying the formula A_{eff}=d_{eff}²π/4 where A_{eff} is the effective cross section and d_{eff} is the effective diameter) preferably has a maximum falling between 0.1 and 10 mm, i.e. with a very large-diameter container it is expedient to apply a throttle opening having a characteristic dimension (effective diameter) falling into this range.

Furthermore, in this embodiment a throttle passage 19 (preferably having a length greater than its width) opens from the throttle opening 18 towards the space surrounding the container; i.e. the throttle passage 19 is disposed between the throttle opening 18 and the spatial region surrounding the container. The throttle passage therefore preferably has an oblong shape, i.e. its length being greater than its width. The throttle opening can be a simple cut-out on the container wall, i.e. a connection between the gas space and the space surrounding the container. The throttle opening is therefore the opening connecting the gas space with the throttle passage, that is, it is essentially the end of the throttle passage being proximate the gas space. In an example the throttle passage 19 has a length of approx. 10-20 mm and a width of approx. 2-6 mm. Of course, other passage dimensions can also be applied; the above values however provide an appropriate gas flow resistance. Besides that, the characteristic dimension of the container can vary in a wide range, from a width of a few centimetres to as wide as a meter.

In FIG. 1 the throttle opening 18 and the throttle passage 19 connected thereto are arranged in a container body 10. If a throttle passage is also arranged connected to the throttle opening then the gas flow resistance is expediently larger compared to the case where only a throttle opening is included. As shown in FIG. 1, only a part of the throttle passage 19 terminates in the throttle opening 18; because to a small extent the throttle passage 19 rises along the side of the container body, this portion of the throttle passage 19 terminates at a certain height; and the rising portion itself can also be interpreted as a part of the throttle opening.

In case a throttle opening is arranged the pressure is preferably always larger in the fluid space 20 than in the gas space 30. In an example with a closed gas space the gas space pressure corresponding to the base position is expediently also set in that manner; when the piston member 14 is displaced from the base position this condition is naturally fulfilled because in this situation the piston member 14 can be moved by the pressure in the fluid space 20 in the direction that results in the reduction of the volume of the gas space 30. Because in the base position the piston member is stationary and thus no pressure is exerted on the gas space by the fluid space, in the embodiment of FIGS. 1 and 2 in this base position the pressure in the gas space 30 is identical with the atmospheric pressure prevailing in the external space brought in fluid communication with the gas space via the throttle opening 18, throttle passage 19 and/or a throttle valve. This base position or a position close to it occurs each time soon after the operation of the device is finished (i.e. after the pressure surge events have passed or have been damped); of course during a pressure surge event there is a momentary pressure rise due to the resistance of the throttle opening as well as the throttle valve, and due to the resistance of the openings the overpressure (relative to the external space) disappears only with a delay.

The embodiments according to FIGS. 1 and 2 have two major advantages. The first advantage is that sealing members 21, 22 of the piston member 14 (in general: the side sealing member (connected to the container) of the piston member, and the sealing member arranged between the piston member and the conduction channel) are only under minimal stress because an overpressure is produced only from the direction of the fluid space 20. This may result in an exceptionally long operating life that is expected to be longer than 10 years. In certain conventional systems the sealing members of the piston are subjected to much greater loads because in these systems large overlaps are required in order to achieve fluid-tightness of the gas space (during compression), i.e. such dimensioning results in a wear-inducing overpressed state in known systems. In order to maintain tightness the sealing member is subjected to significant stress due to the overpressure in the gas space, which shortens its operating life. Another factor contributing to the low stress of the sealing member is that the pressure of the gas space 30 is preferably lower than the pressure of the fluid space 20.

It is noted that the sealing members are subjected to reduced stress also in the closed gas-space example because in the base position or in a rest position close to that (when no pressure surge is present) it is the elastic element which counterbalances the pressure of the fluid space (i.e. its normal pressure), and thus in this example a low-pressure gas (e.g., a gas under atmospheric pressure in the base position) is included in the gas space. In contrast to that, in one of the known approaches described in the introduction the pressure of the fluid space is counterbalanced by high-pressure gas included in the gas space; in order to achieve that a gas under sufficiently high pressure has to be filled into the gas space, and thereby the sealing members are under much higher stress even compared to the closed gas-space example (according to the invention stresses are even lower with an open gas space).

Another advantage of applying an open gas space in the case where the piston member is displaced in different directions (to reduce and increase the volume of the gas space) is that in the gas space increasing efficiency of the elastic element in the gas space the medium (preferably air) is continuously and automatically replenished (refilled) after each operating cycle (no maintenance—e.g. replenishing the gas space—is needed, unlike in the known approach), or in case of any pressure change, through the throttle opening 18. Of course the throttle opening 18 of the gas space 30 has a resistance in itself but the force storage and braking effect is complemented by the throttle valve that provides different transfer performance in the two directions, significantly raising efficiency and outflow resistance.

In the approach of U.S. Pat. No. 9,284,965 B2 mentioned in the introduction, without a force storage or elastic element the gas space has to be pressurized constantly to prevent the volume of the water space from increasing in case of a normal-pressure water flow (when no pressure surge is present). Because of that, as a result of the overpressure in the gas space and the constant pressure in the water space the gas/gaseous material of the gas space permeates the seals and the surfaces in touch with them within a relatively short time. This at first results in the reduction of efficiency and then the failure of the known device. For these reasons, the expected lifetime of the known device is much shorter compared to the device according to the invention. In the case of the invention due to the low pressure of the gas space gas permeates from the gas space much more slowly, and with an open gas space the amount of gaseous medium (e.g. air) that may have permeated the seal to a minimum extent (due to its operating principle no seal is perfect) is replenished instantly (the small amount of gas that penetrates the seal is carried off with the fluid flow in the fluid space).

Due to the throttling effect of the outflowing air, the resistor component (throttle opening 18, throttle passage 19, and the serially connected throttle valve) built into certain embodiments, however, complements the braking effect of the elastic element (the force storage spring 16) during all operating cycles (when the piston member compresses the gas space due to the arrival of a pressure surge event). Of course the main force absorption—force distribution—component is the elastic element.

In the embodiment of FIG. 1 the device according to the invention comprises a container having a container body 10 and a cap element 12 (closure element) that are connected to each other e.g. with a screw thread 13. These components can be connected to each other by other means, e.g. by ultrasonic welding. Connection to a pipe member of a pipe network and the connection of certain components can be made in a different manner than what is illustrated, e.g. by means of quick connectors, bayonet connectors, welding, adhesive bonding, etc.

The embodiment of the invention shown in FIG. 1 is a so-called “serially connectible” embodiment (it can be connected in series with a pipe member of a pipe system wherein pressure surge is to be reduced), and accordingly it has two connectors (connection members), each being adapted to be connected to a respective pipe member (the preferred direction of the fluid flow in this embodiment is described in detail below). On the container body 10 (at the bottom part thereof) a connection member 32 is arranged, and the throttle passage 19 is arranged beside it (in this embodiment the throttle passage 19 runs parallel with the axis of the connection member 32). As shown in FIG. 1, in this embodiment the inner space of the container comprises coaxial cylinders with different internal diameters disposed one after the other corresponding to a stop flange 50 defining the base position of the piston member. The cap element 12 can accordingly be screwed into the container body 10 by means of the screw thread 13. According to the figure the cap element 12 also has a flange adapted to be seated on the end portion of the container body 10.

The inner space of the container is not necessarily configured in a cylindrically symmetric fashion. It can have other shapes wherein the piston member can move; the spatial region wherein the piston member moves is typically shaped as a prism (preferably having a circular base, but the base can also be square, hexagonal, etc.).

The connection member 32 of the container body 10 is an internal connector: the pipe member to be connected is adapted to be screwed or rotated into it. In contrast to that, the connection member 34 arranged on the cap element 12 is an external connection with the pipe member being adapted to be pulled on it (as it will be illustrated later on in a number of figures). In the embodiment of FIG. 1 the connection members 32 and 34 are made from one piece with the container body 10 and the cap element 12, respectively.

The cap element 12 of FIG. 1 comprises an end portion forming a stop flange 50 when the cap element 12 is screwed into the container body 10, i.e. according to the figure the inner space of the container narrows down at the connection of the cap element 12 as seen from the direction of the container body 10. A sealing member 24 extending along the circumference of the stop flange 50 is also arranged at the stop flange 50 between the inside surface of the container body 10 and the portion of the cap element 12 extending into the spatial region encompassed by the container body 10.

The sealing members 21, 22 and 24 are of course configured in such a manner (e.g. with appropriately dimensioned overlaps) that they can perform their sealing function, i.e. for example they are oversized with respect to the groove receiving them such that due to their configuration they are constantly pressed against the surface situated opposite the groove.

Thus, in this embodiment a stop flange 50 facing the gas space 30 is arranged on the inside of a wall of the container, and the piston member 14 comprises a central piston portion 15 shaped to fit—preferably with a small tolerance—into the opening surrounded by the stop flange 50, and a piston shoulder portion 48 arranged around the central piston portion 15 and is adapted to abut against the stop flange 50. In this embodiment the piston shoulder 48 is pressed by the spring 16 adapted to function as an elastic element towards the stop flange 50. In the base position of the piston member 14 the piston shoulder portion 48 is seated against the stop flange 50.

Of course, the base position can be defined not only by being seated against a stop flange; without a stop member the base position can be brought about for example such that the piston member abuts against the upper end portion of the inner space of the container, just as it abuts against the bottom end portion thereof in FIG. 2. In this case arranging a separate piston shoulder portion would of course not be necessary either (if the piston member were adapted to be displaced inside a cylindrical spatial region it could simply have a cylindrical shape).

The piston member is of course displaced from the base position if the device according to the invention is connected via the connection opening to a pipe member carrying a fluid flow (in the non-installed state of the device according to the invention the piston member is pushed into the base position by the elastic element), which fluid also enters the fluid space of the device and its pressure displaces the piston member. The fluid of course also fills the fluid space being in fluid flow connection with the connection opening, and, provided the fluid pressure is high enough, it displaces the piston member (in operation such a normal, pressure surge-free rest position can be brought about that is different from the base position; the piston member is displaced during a pressure surge event from the base position or this rest position). The base position or the rest position near that comes about when no shock wave occurs, i.e. the flow in the connected pipe member corresponds to normal operation. Operation is normal e.g. in case the tap connected to the pipe system comprising the pipe member is continuously open, or has been closed for a long time: in this latter case the fluid flow is stopped, and either no shock wave has formed or the shock wave has already disappeared. Pressure surge is a so-called transient event that occurs in the pipe system connected to a tap (or valve) upon the abrupt closure of the tap (valve).

The base position is also dependent on the pressure conditions prevailing during normal, operational flow. The elastic constant of the elastic element, e.g. of the spring 16 is preferably chosen such that the piston member is displaced from the base position only in the event of a pressure surge. However, especially because supply pressure in the system may fluctuate, it may happen during the use of the device according to the invention that the piston member is slightly displaced from the base position defined by the piston shoulder portion 48 and the stop flange 50 (at a given position pressure counterbalances the force exerted by the elastic element), resulting in a stable displaced position (rest position). Then, the piston member is displaced from this stable displaced position by the pressure surge, compressing the elastic element even more.

As shown in FIG. 1, in this embodiment a receptive opening 38 (groove) adapted for receive the elastic element in its compressed state is formed in the piston end portion of the piston member 14 facing the gas space 30. As shown in FIG. 1, in the base position of the piston member 14 approximately half of the spring 16 is received in the receptive opening 38. As it will be demonstrated in relation to FIG. 2 below, in the position of the piston member 14 where it is pushed to the bottom of the container (the fluid space 20 has maximum volume in this position) the compressed spring is received in the receptive opening 38 in its entirety. The receptive opening 38 is therefore adapted for receiving the elastic element (e.g. a spring) and is shaped to correspond to the shape thereof. If, for example the spring has a circular cross section, the receptive opening is circular.

In the present embodiment the piston member 14 substantially slides along two different surfaces in the inner space of the container. In the present embodiment one of these surfaces is the outside wall of the conduction channel that extends along the central part of the device and comprises inner spaces 54, 56 and 58. In this embodiment the conduction channel is formed by the seal fixing (seal clamping) portion 17 of the cap element 12 and a guiding pin 25. These components are encompassed in a bushing-like manner by the piston member 14. The above mentioned outside wall is the side wall of the guiding pin 25 and is terminated in a shoulder portion 52; and a sealing member 22 (sealing ring, simmering ring) is arranged such that it is supported against the shoulder portion 52. The sealing member 22 is supported from above by the portion 17 that forms an extension of the outside wall of the conduction channel and that in this embodiment has a cylindrical shape. In this embodiment the portion 17 (that forms a part of the conduction channel) and guiding pin 25 are encompassed by the piston member 14, with a corresponding cylindrical conduction passage being disposed therein. The narrowing portion of the guiding pin 25 is encompassed by the portion 17 of the cap element 12. Sealing between the piston member 14 and this slide surface is therefore provided by the sealing member 22. In this embodiment therefore the fluid space 20 encompasses the conduction channel and is arranged sideways with respect to the flow direction.

The other slide surface is formed by that portion of the cap element 12 which constitutes the continuation of the stop flange 50 towards the connection opening 28. Seen from the direction of the bottom portion of the container (as shown in the figure) therefore the stop flange 50 narrows down the inner space of the container, the inside cross section of the container above the stop flange 50 being determined by the protrusion of the stop flange 50. The piston member 14 is supported (also) against the side wall of the wider inner space situated at the bottom part of the container, and a sealing member 21 is arranged circularly around the piston member 14 on this support surface. The piston member can be supported only against this surface (can slide only along this surface), but in that case it is required that the above described two slide surfaces (guide surfaces) have an appropriately small gap between the piston member and the wall of the container such that fluid enters the gap from the fluid space to the smallest extent possible.

The piston member divides the inner space of the container into a fluid space and a gas space, the piston member is sealed against the walls guiding it, the sealing members 21 and 22 are arranged accordingly in the embodiment illustrated in FIG. 1, the fluid space 20 being separated from the gas space 30 collectively by the piston member 14 and the sealing members 21 and 22. The sealing members 21, 22 and 24 are by way of example O-rings; they may have a profile different from what is illustrated.

The inner space 58 is surrounded by the cylindrical portion 17, i.e. the width of the inner space 58 is determined by the inside diameter of the portion 17. In FIG. 1 a fluid transfer opening 36 is shown in front view. In the longitudinal direction the fluid transfer opening 36 extends from the guiding pin 25 as far as slightly under the connection opening 28. Thanks to the positioning of the piston member 14 and to the sectional view, through the fluid transfer opening 36 the outline of the end portion (the top) of the piston member 14 facing the fluid space 20 is shown, and the line corresponding to the bottom plane of the flat portion (the portion adapted to form the base of the connection member 34) of the cap element 12 is also shown through the fluid transfer opening 36.

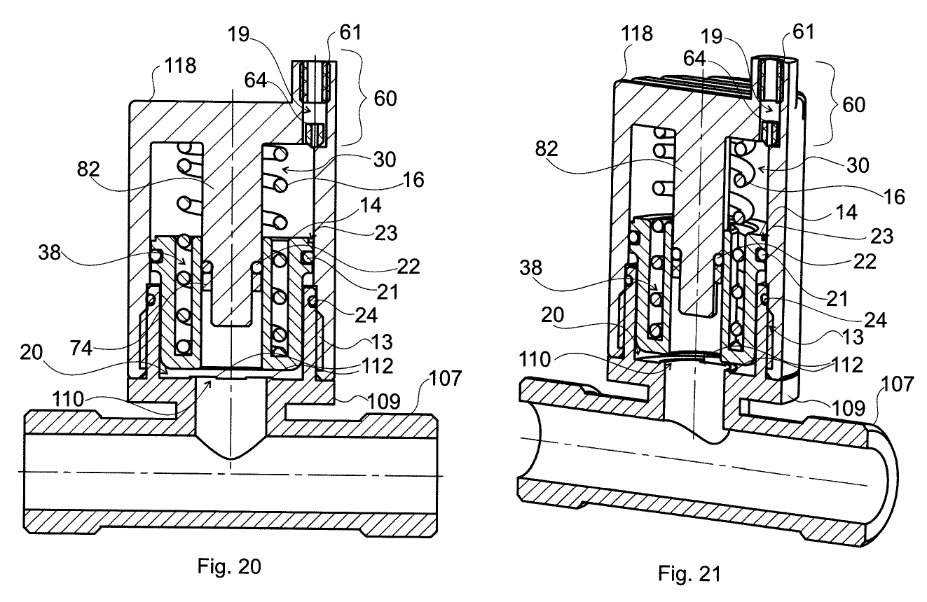

The fluid transfer opening 36 is shown also in FIG. 4 that illustrates the cap element 12 in underside view. This figure shows that in this embodiment two fluid transfer openings 36 are arranged on the seal retaining portion 17. In FIG. 4 the underside of the above mentioned flat portion of the cap element 12 is shown from below. According to the above the fluid transfer opening 36 extends further upwards relative to the bottom side of this flat portion; this is illustrated in FIG. 4: in the figure indentations 37 (grooves) are shown that extend from the fluid transfer openings 36 and are cut into the bottom portion of the cap element 12. Instead of the indentation 37 a fluid flow space can also be formed by spacer members (e.g. protruding knobs) arranged in the bottom portion of the cap element 12 (see embodiments of FIGS. 20-23).

The indentation 37 is also shown in FIG. 1. As illustrated by the example of FIG. 3 (very similar to the embodiment of FIG. 1) in the base position the piston member 14 does not reach the inside surface of the cap element 12, and thus in this embodiment the indentation 37 does not play a significant role, it is included in FIG. 1 for illustrative purposes only (see below).

In embodiments wherein the piston member extends as high as the inside surface of the cap element 12 (the cap element 12 would be configured so or the piston member 14 would be longer) the indentation 37 has the following advantages. The fluid flowing through the conduction channel (and the shock wave forming in the fluid) can enter the region above the piston member (which in the base position extends as high as the bottom part of the cap element) through the indentation 37, the fluid thereby being able to impact the portion (surface) of the piston member 14 that faces the fluid space 20; that is, before the displacement is initiated the fluid is able to exert a pressure on the piston member 14 only through the piston member surface corresponding to the indentation 37. In case therefore an indentation 37 (or more than one indentations) are included it becomes possible to further reduce the size of the container-piston member assembly because it is not necessary any more to space apart (in the base position) the piston member from the end of the inner space of the container (the corresponding flat portion of the cap element 12), i.e. in the base position the volume of the fluid space may even be reduced to zero. In an embodiment of the invention therefore there is arranged an indentation 37 or at least one spacer member forming a fluid flow space portion being in fluid flow connection (fluid communication) with the connection opening 28 in any position of the piston member is arranged on the part of the container situated opposite the end portion of the piston member 14 facing the fluid space 20.

In the embodiment of FIG. 1 the device according to the invention comprises a conduction channel extending through the container, passing through the piston member 14, connecting the connection opening 28 with a supplementary connection opening 55, and being adapted for carrying a fluid flow. This embodiment is therefore of the flow-through type (having two connection members, i.e. two connection openings). In the present embodiment the interconnection between the conduction channel and the fluid space is provided such that at least one fluid transfer opening 36 connecting the inner space of the conduction channel and the fluid space 20 is formed in the side wall of the conduction channel. The conduction channel and the interconnection can also be formed in a different manner.

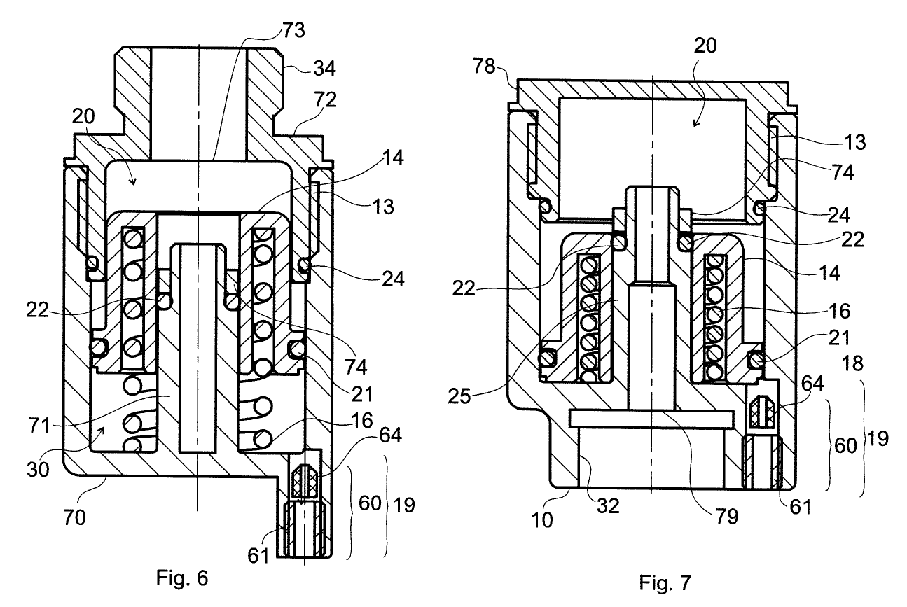

In the present embodiment the conduction channel is configured such that the inner space 56 has a smaller cross-section (with a continuously narrowing inlet 26 from the direction of the supplementary connection opening 55) than the inner space 54 of the conduction channel, and the inner space 58 expediently has a relatively larger cross section again. The supplementary connection opening 55 is adapted for introducing fluid. In general, in an embodiment of the device according to the invention between the supplementary connection opening and the connection of the conduction channel to the fluid space the conduction channel preferably comprises a contracted portion with a cross section that is smaller than the cross section at the connection to the fluid space (at the interconnection, i.e. at the fluid transfer allowing opening or at the connection according to FIG. 6 the cross section of the conduction channel is already large). Thus, the cross section thereof taken at the at least one fluid transfer allowing opening (the opening functioning as a connection with the fluid space; in this embodiment the cross section of the inner space 58 is meant by this cross section) is larger than the cross section taken in the conduction channel of at least one portion between the at least one fluid transfer allowing opening and the supplementary connection opening (the inner space 56 corresponds to this cross section).

In the present embodiment the fluid flows from the supplementary connection opening 55 towards the connection opening 28. Such a configuration is also preferable because a pressure drop may occur in the fluid space 20 due to the increasing cross section of the conduction channel (a larger cross-section spatial region being available to the liquid), in the event of the displacement of the piston member from the base position this contributes to the effect of the elastic element when the piston member is returning to the base position: the piston is urged towards its base position also by this pressure drop. The device can of course also operate with a narrowing or a constant cross-section conduction channel.

An opposite-direction movement of the piston member occurs when a shock wave generated by a pressure surge arrives to the fluid space of the device according to the invention: it causes liquid congestion, pressure rise in the fluid space 20. This exerts a pressure on the piston member 14 and has a compressive effect on the force storage component acting on the piston member 14. An expansion buffer region (a possibility for expansion, an elastic torsion region) is then provided by the gas space 30—in the presence of the resistance of the elastic element (and of the throttle valve and optionally of the throttle opening 18 and the throttle passage 19)—for the fluid that was accelerated in the flow but is forced to rapidly decelerate (undergo a negative acceleration), i.e. the fluid space of a fluid network is complemented applying the device according to the invention with a fluid space that is capable of expansion above a certain pressure occurring in the flow. Accordingly, the gas space made flexible by the elastic element capable of deformation and compression can also reduce pressure surge in the fluid because—unlike the case where a device for reducing pressure surge is not applied—“braking” is not carried out over a time period with near-zero length but the braking period is extended by the duration of filling up the fluid space 20, the damping effect being assisted also by the energy absorption capability of the piston member 14 that is present thanks to the temporary pressure increase in the gas space 30 and to the elastic element. A temporary pressure rise occurs in a closed gas space and also in the case where there are arranged a throttle opening, a throttle passage and a throttle valve constituting a flow resistance. Applying the device according to the invention thereby a large dynamic pressure surge is transformed into a smaller (more static) pressure surge that is extended (“blurred”) in time. By a dynamic pressure surge a short-duration (instantaneous) high pressure is meant, while the term “static pressure surge” refers to a lower pressure value sustained over a longer time period. Slow braking is therefore provided by a braking force produced applying a buffer space, the elastic element and the gas outflowing from the gas space.

As shown in FIGS. 1 and 2, the piston end portion of the piston member 14 is configured such that in a fully compressed state of the elastic element (in this embodiment a spring 16) it fits against the wall of the container (is pressed to the container wall, see especially in FIG. 2), and a circumferential recess 23 (notch) is formed on the first piston end portion such that, in the event that the first piston end portion is fitted against the wall of the container, at least a part of a throttle opening 18 of the throttle valve opening into the gas space is covered by a part of the circumferential recess 23 (i.e. it is to be arranged in connection therewith). Because the throttle opening 18 is formed at a marginal portion of the container, in this embodiment the circumferential recess 23 is arranged along the outer circumference of that piston end portion of the piston member 14 which faces the gas space 30. If the throttle opening was not situated at the marginal portion of the container the circumferential recess would also be situated further inside.

Apart from the circumferential recess 23 the above described components can be included also in an example wherein the gas space is closed (the arrangement of the circumferential recess 23 is needless with a closed gas space, but it can of course be included in such an arrangement). In the event of a pressure surge, that is when the piston member 14 is displaced in a direction that results in the reduction of the volume of the gas space, the gas inside the closed gas space gets compressed and its pressure increases. Simultaneously with the pressure increase the elastic element (e.g. the spring 16) is compressed, i.e. the piston member 14 is slowed down by the collective action of the compressed gas and the elastic element, thereby damping the pressure surge effect.

The closed gas space according to the example is not required to be filled with high-pressure gas since the gas has a braking effect also with lower pressure, and in the device according to the invention the main braking-counterbalancing action is performed by the elastic element. In such an example it is also preferable to apply lower-pressure gas because thereby the seals are subjected to lower loads compared to known technical solutions. Preferably the gas space is filled with air having a pressure that in the base position of the piston member is the same as the outside atmospheric pressure. Of course, high-pressure gas can also be applied in the gas space in this example.

In the embodiment of FIG. 1 the gas space 30 is, however, not closed because there is arranged a throttle opening 18 (and a throttle valve 60 opening from it). In this embodiment, as illustrated in FIG. 1, the throttle opening 18 is configured such that the throttle passage 19 is connected to the bottom face of the container body 10 (against which the piston member 14 is pressed at its largest-displacement position) but the throttle opening 19 (and thus also the throttle opening 18) extends up into the side wall of the container to a small extent. The amount of this upward extension—as shown in FIGS. 1 and 2—is identical with the depth of the circumferential recess 23 (i.e. its vertical extension as shown in FIG. 1).

Expediently a single throttle opening 18 and a single throttle passage 19 (connected to the throttle opening) are arranged, so air can flow through the container wall into the gas space 30 only at a single location (the inflowing air can disperse through the recess 23), and can of course flow out therefrom at a single location; pressure therefore rises at the throttle opening (outflow opening) that constitutes a flow resistance.

In the phase illustrated in FIG. 2 the piston member 14 is displaced to the maximum displacement relative to the base position (i.e. the piston member 14 is in its state having the maximum distance with respect to the base position). This state corresponds to the maximum-compression state of the spring 16, brought about by the overpressure occurring in the fluid space 20 as a result of the pressure surge. In this state the volume of the fluid space 20 is significantly different from the volume of the gas space 30 (the fluid space 20 has greater volume, with the volume of the gas space 30 being reduced to a minimum, i.e. almost to zero). Pressure rises in the conduction channel as a result of the pressure surge, which causes a pressure rise also in the fluid space 20; the fluid space 20 is filled up from the conduction channel through the fluid transfer openings 36.

Because there is disposed only a single throttle opening 18, inflowing air could “push” the piston member 14 at only a small cross-sectional area, i.e. on the cross section of the throttle opening 18. This push effect can be increased significantly by the arrangement of the circumferential recess 23. This is because in that case inflowing gas can flow around the piston member in the circumferential recess 23 (i.e. in the case illustrated in FIG. 2 where the piston member 14 is situated at the bottom of the gas space 30), and thus it can exert a push effect on the piston member 14 across a much larger surface area. It can essentially launch the piston member such that a gap is subsequently formed between the piston member 14 and the bottom face of the container. This effect is also produced when the throttle opening does not extend into the side wall as inflowing gas can enter the circumferential recess 23 through the throttle passage 19 also in that case. If the throttle opening 18 extends also over the side wall of the container, this effect can be made more intensive. In FIG. 1 an inflowing gas stream 40′ is indicated, while in FIG. 2 an outflowing gas stream 42′ is shown.

FIG. 3 illustrates an example for easier understanding of the invention. The example of FIG. 3 differs from the embodiment of FIG. 1 in that in the example of FIG. 3 there is no throttle valve 60 (to be described later on) in the throttle passage 19 (in contrast to the embodiment according to FIGS. 1 and 2). In FIG. 3 both the inflowing gas stream 40 and the outflowing gas stream 42 are indicated.

In the case where a throttle passage is also formed it is to be dimensioned to have an appropriate length such that a throttle valve can be accommodated therein, i.e. the throttle valve can be formed with the throttle passage. As described above, a throttle valve is applied in the device according to the invention. The main function to be performed by the throttle valve is throttling, i.e. in addition to provide for continuous inflow and outflow it has to ensure that the outflow resistance is larger than the inflow resistance. Requirements for the throttle valve can be fulfilled in an especially preferable manner by applying a throttle valve comprising a moving member (moving element) arranged in a throttle passage. However, a throttle valve with the characteristics according to the invention can also be implemented in a different manner.

From the point of view of the flow the throttle valve 60 adapted to allow for bidirectional flow is connected in series with the throttle passage 19. By including a throttle valve efficiency can be increased relative to the case where there is no throttle valve in the throttle passage.

The throttle valve expediently provides different transmitted flow rates (constitutes a different resistance) in different flow directions (in case of inflow and outflow through the throttle passage 19). It is especially expedient to apply in the invention a throttle valve that has a gas flow resistance that is greater for outflow from the gas space (when the volume of the gas space is decreasing; discharge, venting off) than for inflow into the gas space (when the volume of the gas space is increasing; fill-up, suction). The throttle valve thus operates such that the rate of flow is lower for gas flowing out of the gas space (when the volume of the gas space is being reduced by the piston member 14) than for air flowing in through the throttle passage 19 when the piston member 14 is on its way towards the base position. With such a configuration an increased flow resistance for gas outflow rises the pressure in the gas space, this pressure increase is added up to the force exerted by the spring when braking a pressure surge. In the case of inflow it is expedient to let gas (air) in as fast as possible, that is why a much lower flow resistance is applied for inflow compared to outflow.

In an embodiment of the device according to the invention therefore the throttle valve comprises a moving member being arranged in a throttle passage connecting the gas space and the space surrounding the container, being movable between a first end portion (this is the end portion of the throttle passage situated in the direction of the space surrounding the container relative to the moving member) and a second end portion (this is the end portion of the throttle passage situated in the direction of the gas space of the container relative to the moving member) of the throttle passage, and the moving member, the first end portion and the second end portion of the throttle passage is configured to allow the continuous gas flow in both directions.

As it is illustrated also with examples, such a throttle valve with a moving member can be implemented in a number of ways, see the configuration related considerations in more detail below. The components of the throttle valve (the moving member, passage reduction elements) can be made of solid or resilient material (e.g. rubber, or a plastic with relatively high strength or with a small degree of elasticity).

Furthermore, in the illustrated embodiments the moving member is arranged in a guided manner in the throttle passage. Such a configuration is also conceivable wherein the above requirements are fulfilled applying a configuration where the moving member is not required to be guided.

In a further embodiment wherein the moving member is guided inside the throttle passage the throttle valve comprises a passage narrowing element formed with a conduction passage between the throttle passage and the space surrounding the container, and the moving member is arranged in the portion of the throttle passage extending from the passage narrowing element towards the gas space (throttle opening), and has a second end (end portion; facing the outside-lying passage narrowing element) adapted for at least partially covering the conduction passage of the passage narrowing element. The moving member is configured for preventing passage through the throttle opening of the throttle passage opening into the gas space. The moving member is configured such that it cannot pass through the throttle opening. The phrase “the moving member is guided” is taken to mean that the moving member is prevented from being reversed inside the throttle passage (i.e. the reversal of its orientation of the end in the throttle passage is prevented). This can be achieved by applying a moving member that fits appropriately closely inside the throttle passage or that has an appropriate width-to-length ratio (i.e. an oblong shape). The moving member is of course appropriately lightweight in order that it can be displaced effectively by the gas flow.

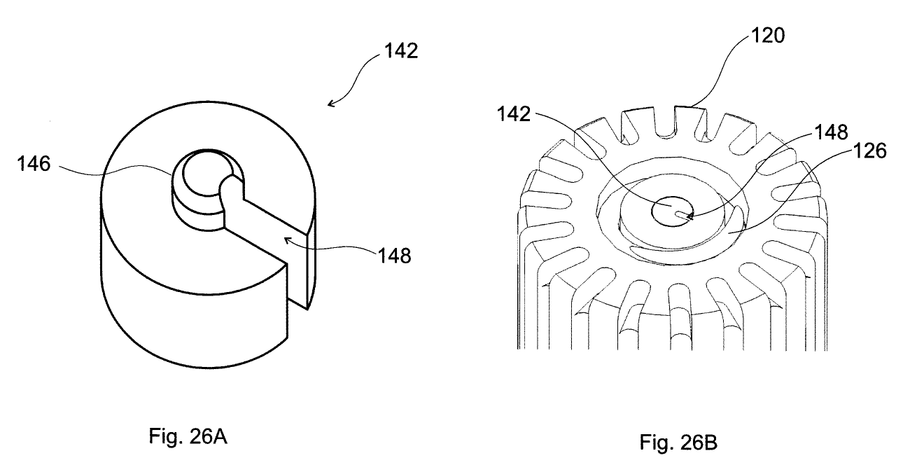

A moving member with the above features can be implemented in a number of ways, in FIGS. 9 and 11 two exemplary moving members are shown, and further moving members are shown in FIGS. 26A, 27A and 29A, 29B. In the embodiment of FIGS. 1 and 2, a moving member 64 is arranged, with a conduction passage 66 being formed between a first end 63 (end portion; facing the throttle opening 18) and a second end 65 (end portion; facing the surrounding space) thereof. A magnified view of the moving member 64 is shown in FIG. 9. A magnified view of a differently configured moving member 91 is shown in FIG. 11.

The throttle valve 60 is shown in FIG. 1 in a partially closed state (the moving member 64 partially obstructs the throttle opening 18); and inflowing gas stream 40′ is also illustrated in the figure. In the state illustrated in FIG. 1 the volume of the fluid space 20 is nearly identical to the volume of the gas space 30.

In the embodiment of FIG. 1 a conduction passage 62 of a passage narrowing element 61 is not blocked by the moving member when gas is flowing out of the gas space 30 because the gas can also flow through the conduction passage 62. According to the above, this flow has a much lower rate compared to the case where air can also flow around the moving member (such a flow pattern typically occurs during gas inflow), i.e. the throttle valve 60 comprising the moving member 64 also has a larger resistance when the volume of the gas space 30 decreases than in case the volume of the gas space 30 increases. This configuration is therefore an example for configuring the ends of the moving member and the end portions of the throttle passage such that the moving member cannot leave the throttle passage, and bidirectional flow (gas inflow and outflow) is allowed for.

In FIG. 9 it is illustrated that the passage narrowing element 61 is screwed into the throttle passage 19. The passage narrowing element 61 can of course be fixed in the throttle passage 19 by other means. In FIGS. 1 and 9 the conduction passage 62 has slightly different width. It can be readily understood that the cross section of the conduction passage 62 can be chosen arbitrarily; by modifying this parameter the outflow rate from the gas space 30 can be adjusted.

It is also shown in FIGS. 1 and 9 that the end of the moving member 64 facing the throttle opening 18 narrows down. Narrowing down has a similar effect to arranging a circumferential recess 23 on the piston, i.e. when the moving member 64 is “attacked” by air flowing out from the gas space 30 then, due to the narrowing configuration, air can exert a pressure on it not only at the section extending into the throttle opening 18 but the outflowing gas can also flow around the end (end portion) through the gap forming between the end portion of the throttle passage 19 and the moving member 64 thanks to the narrowed section, and thus the piston can be more efficiently displaced from its terminal position by the outflowing gas.

In FIG. 1 the piston member 14 is illustrated in a state wherein it is “ascending” i.e. approaching its base position. In this state the moving member is lifted by the inflowing gas that flows towards the gas space 30 partly through the conduction passage 66 and partly around the moving member 64. FIG. 2 depicts the same embodiment as FIG. 1, illustrating the moment when the piston member 14 arrives at the bottom of the inner space of the container, driving gas out from the gas space 30 and pushing the moving member 64 downwards on the passage narrowing element 61 (on the stationary member) such that the end 63 of the moving member 64 blocks the conduction passage 62 of the passage narrowing element 61. In FIG. 2 it is illustrated that the outflowing gas stream 42′ can still travel through the conduction passage 66 of the moving member 64 and through the conduction passage 62 of the passage narrowing element 61. The outflowing gas stream 42′ is however determined by the cross section of the conduction passage 66 rather than that of the conduction passage 62 (since in the illustrated embodiment the cross-sectional area of the conduction passage 66 is smaller), and thus the outflowing gas stream 42′ has relatively low flow rate, lower than the inflowing gas stream 40′ (air inflow) illustrated in FIG. 1.

Thus, in the embodiment of FIG. 1 it is ensured by the configuration that the moving member 64 cannot leave the throttle passage 19 (the moving member has an appropriate width and it is guided, by virtue of its configuration it is not capable of crossing the throttle opening 18 since it cannot pass through it, while it is prevented from entering the surrounding space by the passage narrowing element 61). Besides that, the illustrated configuration provides for a bidirectional flow, i.e. the throttle valve 60 is open to flow (lets through) at any position of the moving member 64. This is ensured by the conduction passage 66 of the moving member 64. In the case of gas outflow it is ensured by the limited sideways motion of the moving member 64 (it has a sufficient width) that outflow occurs only through the conduction passage 66. The inflow rate is larger rate because in that case air can also travel outside the conduction passage 66, around the moving member 64.

The embodiments illustrated in FIGS. 1 and 2 (and also the example according to FIG. 3) are of the flow-through type, i.e. the fluid space 20 is connected—in the case of connecting the device in a fluid network—to a fluid space that extends through the container and carries a flowing fluid. In the embodiments of FIGS. 1 and 2 a respective pipe member can be connected to the connection members 32, 34 arranged at both ends of the container, in which case a fluid flow can be carried by a conduction channel comprising inner spaces 54, 56 and 58. The preferred direction of the fluid flow is from the bottom towards the top as shown in the figure, i.e. the fluid enters the device at the end of the conduction channel situated at the inner space 54 and flow out through the inner space 58. The fluid transfer opening 36 is shown in all of FIGS. 1-3; when the piston member 14 is in a lower position (FIGS. 1 and 2) the fluid transfer opening 36 can be seen to a greater extent. Through this fluid transfer opening 36 the fluid is carried from the inner space 58 of the conduction channel into the fluid space 20, so the fluid flowing in the conduction channel enters also the fluid space 20 (and fills it up).

When a pressure surge (a shock wave of a pressure surge) arrives in the conduction channel, this pressure surge also occurs in the fluid included in the fluid space 20. As a result of the pressure surge the pressure of the fluid situated in the fluid space 20 rises rapidly, which causes the fluid space 20 to expand due to the displacement of the piston member 14. The energy required for compressing the spring 16 and the gas situated in the gas space 30 is provided by the pressure increase, and therefore the shock wave propagating in the fluid flow loses energy. This energy is stored in the compressed elastic element (and, in the example with a closed gas space 30, in the gas situated in the gas space), and accordingly, when the pressure in the fluid space 20 starts to drop again (when the shock wave generated by the pressure surge has passed) under the effect of the stored energy the piston member 14 is again displaced towards its base position (it is urged towards the base position by the expansion of the elastic element and, optionally, the gas compressed inside the closed gas space).

Thereby the power of the pressure surge (the corresponding pressure difference or pressure surge) can be significantly reduced with the device according to the invention, and thus the harmful effects of the pressure surge can be eliminated.

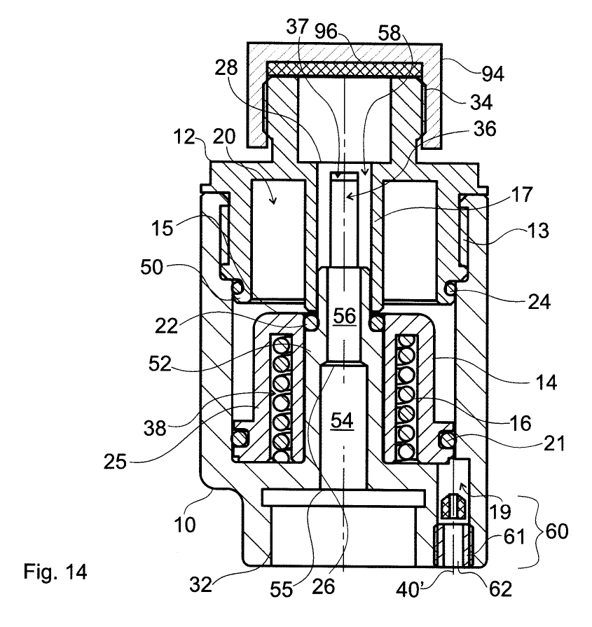

This advantageous effect can be reached also in further embodiments of the device according to the invention. In FIGS. 6, 7, 8, 10, 12, 13, 15, 24A and 24B embodiments of the non-flow through type, i.e. embodiments with a single connection opening are illustrated (these may be termed “single-connection” embodiments). Besides that, in FIG. 14 such an embodiment is illustrated that is of the flow-through type (has two connections for pipe members), but in the embodiment of FIG. 14 one of the connections is closed, and thus this embodiment also operates as a single-connection device for reducing pressure surge.

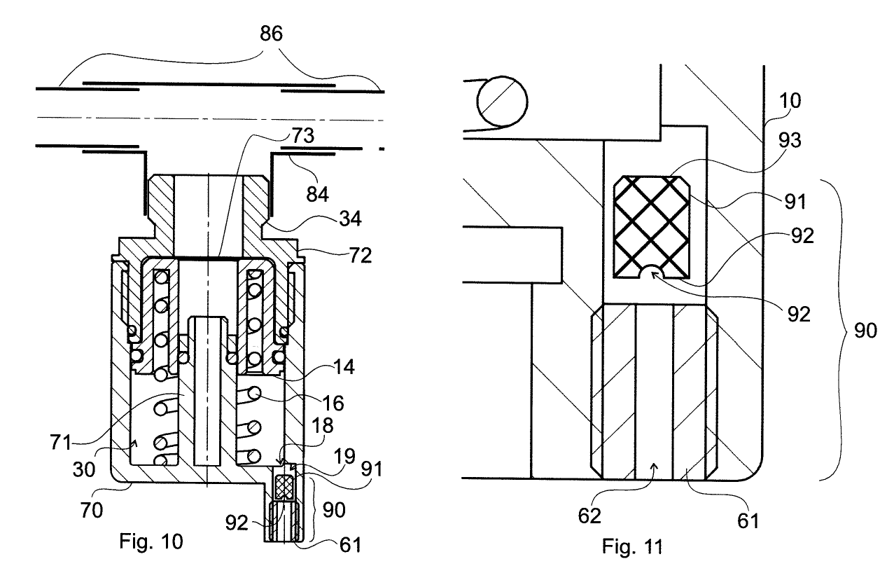

The embodiments of FIGS. 1 and 2 and the example of FIG. 3 can therefore be connected in series in a pipeline. This is illustrated in FIG. 5, wherein pressure surge reducing devices 200 are connected in a pipeline leading from cold-water and hot-water pipe connectors 205a and 205b to a tap 220 situated on a washbasin 210. The embodiment of FIG. 6 (and other single-connection embodiments) can be connected in parallel to a fluid system (e.g. a water supply system), as it is illustrated in the figures to be explained below (FIGS. 10, 12, 13 and 15).

In the embodiment of FIG. 6 the container comprises a container body 70 and a cap element 72. The container body 70 differs from the container body 10 in that a connection opening (inlet) is not formed thereon. The cap element 72 is also different from the cap element 12. In this embodiment a connection opening 73 has larger cross sectional area than the connection opening 28 (fluid can more efficiently flow through it into the fluid space). In the present embodiment therefore the portion 17 shown in FIGS. 1-3 is not arranged, with the sealing ring 22 kept in place by a retaining ring 74 instead of the portion 17, the retaining ring 74 being attached to the outside surface of a guiding pin 71. Of course the cap element 12 can be arranged also in such a single-connection embodiment, but by utilizing a cap element 72—thanks to its configuration—the fluid space 20 is more easily accessible from the connection member 34 and thus the device can be applied more efficiently for reducing pressure surge. In this embodiment the fluid space 20 extends into the interior of the guiding pin 71 but the inner space of the guiding pin 71 is open only at the end facing the fluid space 20, the other end of the guiding pin 71 is closed off, so in this embodiment a conduction channel is not formed. In this embodiment the slide surface provided by the guiding pin 71 and extending through the piston member 14 is shorter compared to the embodiments according to FIGS. 1 and 2, this, however does not affect the operation of the piston member 14.

A flow-through embodiment (an embodiment comprising two connection openings) is conceivable that is obtained by arranging a supplementary connection opening in the container body 70 at the end of the guiding pin 71 facing the container body 70. Thereby, a conduction channel is formed between this connection opening and the connection opening 28, the conduction channel being in fluid communication with (i.e. is not separated from) the fluid space 20 according to FIG. 6.

In this embodiment, as is illustrated in FIG. 10, the pipe member carrying fluid flow can therefore be connected to the connection member 34. In FIG. 10 the embodiment according to FIG. 6 is illustrated connected to a pipe member 84, the pipe member 84 being a T-member; this T-member being connected between straight pipe members 86 through which a fluid carried by a pipe network, e.g. water, can flow. As a result of a pressure surge produced in the fluid carried in the pipe member 86 a pressure rise occurs also in the fluid space of the device for reducing pressure surge, resulting in that—as with the embodiments of FIGS. 1 and 2 and the example of FIG. 3—the piston member 14 is displaced, with the volume of the fluid space 20 starting to increase at the expense of the volume of the gas space 30.

In the embodiment of FIG. 6 the same throttle valve 60 is arranged as in the embodiments of FIGS. 1 and 2. This throttle valve 60 is, however, arranged in a separate protrusion 76 because unlike in the embodiments of FIGS. 1 and 2 there is no connection member extending beside it. This does not bring about a change in the way the throttle valve 60 is operated because the device according to this embodiment can be connected to the pipe member carrying the fluid through the connection member 34, and there is usually plenty of space for the guiding pin under the device. Independently from the fact that fluid is fed into the fluid space 20 through the connection member 34 rather than through the connection member 32 shown in FIGS. 1-3, the operation of this embodiment is analogous to the above described embodiments because in the event of a pressure surge a pressure rise occurs in the fluid space 20 and the piston member 14 is displaced also. In this embodiment the fluid space 20 is in fluid communication with the connection opening 73.

The throttle opening can be arranged not only at the extremity of the bottom cover plate of the container body 70 against which the elastic element is supported but also slightly further inwards, if its connection to the gas space 30 is ensured (i.e. it cannot be arranged under the guiding pin 71). In such a case the opening would not extend upwards along the side of the container body, and would potentially be dimensioned differently than the throttle opening 18.

A further embodiment of the device according to the invention is illustrated in FIG. 7. In this embodiment a container body 10 is applied, the difference compared to the embodiments of FIGS. 1 and 2 is in the cap element. In the present embodiment the device comprises a cap element 78 that does not have a connection opening but is adapted to simply cover the fluid space 20 at the top. If in the base position the piston member 14 reaches the flat portion of the cap element 78 then at least one indentation configured like the indentation 37 can be preferably arranged also in this embodiment. In this embodiment the device comprises a connection opening 79 situated at the bottom of the device beside the throttle valve 60 as illustrated in the figure, and is configured in a fashion similar to the supplementary connection opening 55 in the embodiment of FIG. 1. In this embodiment therefore the fluid space 20 is in fluid communication with the connection opening 79 as illustrated in the figure. The device of FIG. 7 can be connected to a pipe member carrying a fluid flow through a connection member 32, so this embodiment is also a parallel-connected one: it can be connected to a straight pipe segment by a T-member.

As a result of the pressure surge the shock wave of the pressure surge enters the device connected to the pipe system through the connection opening 79, and due to the increased pressure in the fluid space 20 it moves the piston member 14 along the fluid space 20 in the direction of compression of the spring 16. Thereby the pressure surge is damped—with the help of the spring 16 and the gas situated in the gas space 30—by the device according to this embodiment. The advantage of this embodiment is that the fluid must travel a longer distance to the damping element (i.e. to the piston member 14), and meanwhile the shock wave may lose some of its intensity. A further advantage of this single-connection embodiment compared to the single-connection embodiment of FIG. 6 is that it has a more compact configuration, with no protrusion extending from the structure unlike the protrusion 76 shown in FIG. 6.

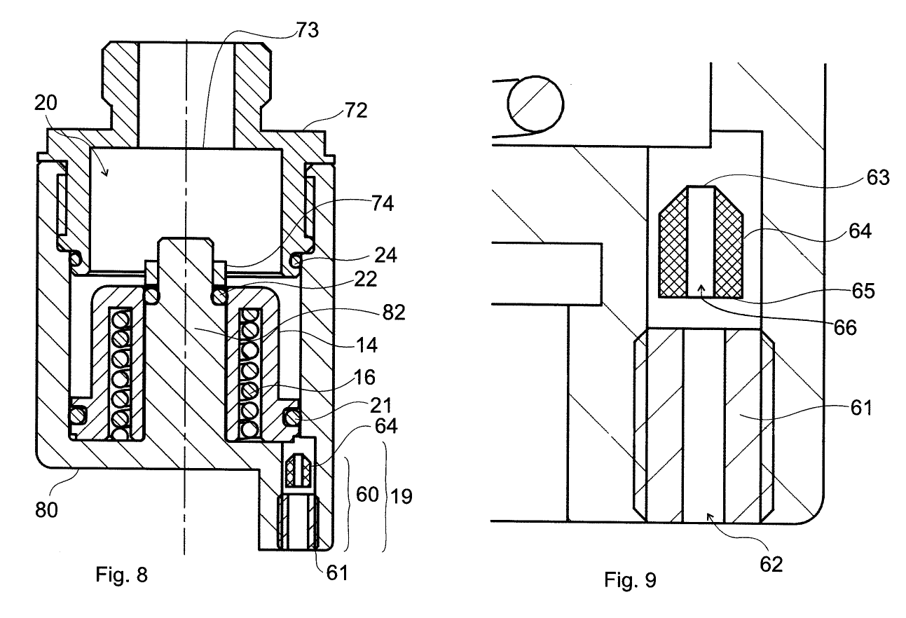

In FIG. 8 a still further embodiment of the invention is shown that is very similar to the embodiment of FIG. 6. The embodiment of FIG. 8 comprises a solid guiding pin 82 connected to a container body 80, which guiding pin, in contrast to the guiding pin 71 does not have an inner space or cavity that could contribute to the volume of the fluid space 20. Otherwise this embodiment operates in the same way as the embodiment of FIG. 6.

In FIG. 10 a further embodiment is shown; with a throttle valve 90 thereof being illustrated in a magnified view in FIG. 11. The throttle valve 90 comprises the passage narrowing element 61 but is configured differently from the throttle valve 60 as far as its moving member 91 is concerned. In the moving member 91 there is not arranged a longitudinal conduction passage 66, but instead there is a passage 92 formed on the bottom portion thereof. This passage can be termed a control passage; it can be implemented as a flute, notch, groove, recess, channel, cutout, etching, roughening or a combination thereof; the passage being implemented by injuring the material of the second end of the moving member 91.

The moving member 91 has a first end 93 and a second end 95, the passage 92 is formed on the second end 95. The edges of the end 93 are rounded off, i.e. as with the above, the moving member 91 also narrows down in the direction of the first end 93. The passage 92 is adapted for providing that a low amount of outflowing gas can enter the conduction passage 62 through it even in the case when the end 95 is seated on the upper face of the passage narrowing element 61 facing the moving member and blocks the conduction passage 62. The rate of gas outflow can be adjusted by adjusting the dimensions of the passage 92. The passage 92 preferably extends transversely along the preferably circular end 95. Gas flowing beside the lateral side of the moving member can enter the passage 92. In an analogous manner, a passage providing the same functionality can be arranged at the end portion of the passage narrowing element 61 facing the second end 95 (see also the embodiment according to FIGS. 29A, 29B), too. Such a passage would preferably extend transversely along the passage narrowing element 61 such that it can ensure that outflowing air can enter the conduction passage 62 at any position of the moving member. It is necessary the rate of outflowing air because a non-zero amount of air outflow is preferable but in order to preferably increase flow resistance outflowing gas has to be prevented from being able to flow out in an unrestricted manner through the throttle passage 19.

In the throttle valve 90 the moving member 91 is prevented from being removed from the throttle passage 19 by means of a configuration similar to the throttle valve 60. Outflow can be provided by the arrangement of the passage 92, while inflow is provided by the appropriate configuration of the throttle passage 18 and the end of the moving member 91 facing it (a narrowing-down moving member 91 arranged to extend into the throttle opening 18—that extends upwards on the side wall—such that flow around the moving member 91 can be ensured). An inflow rate greater than the outflow rate can be ensured by the appropriate dimensioning of the passage 92 and the mutually fitting portions of the throttle opening 18 and the moving member 91.

In an embodiment of the device according to the invention a passage is formed on the second end of the moving member or at the end of the passage narrowing element facing the second end, the passage being adapted for allowing gas flow between the inner space of the throttle passage and the conduction passage of the passage narrowing element in case the conduction passage of the passage narrowing element is covered by the moving member. This passage also constitutes a gas flow resistance, i.e. as with the conduction passage 66 of the moving member 64 it has sufficiently small dimensions (this follows from the fact that already the throttle opening itself and the throttle passage connected thereto constitute a gas flow resistance). It is therefore a matter of choice whether the passage is formed at the second end of the moving member or the end of the passage narrowing element facing the second end; the passage operates when the moving member is supported against the passage narrowing element. The second end and the end of the passage narrowing element facing the moving member preferably has a flat shape; in this case the passage is disposed in the flat portion of the second end.

In an example the moving member has a length of approximately 3-5 mm and a width of approximately 2-4 mm, with the diameter of the conduction passage 66 being approximately 1 mm. In another example the depth of the passage 92 is approximately 0.5 mm but it may be sufficient to apply a passage with a depth of a few hundredths or tenths of a millimetre, i.e. the depth of the passage is typically at least 0.05 mm (much larger than surface roughness or potential surface defects from manufacturing), preferably at least 0.1 mm. These values should be applied for all cases wherein outflow is provided by an appropriately arranged low-depth passage. Inflow is typically provided by including conduction passages, passages or gaps with a characteristic dimension (e.g. effective diameter) larger than that.

The embodiment of FIG. 10 differs from the embodiment of FIG. 6 only in that it comprises a throttle valve 90 instead of a throttle valve 60. In FIG. 10 the device is depicted connected to a pipe member 84 that is a T-member, with pipe members 86 being connected thereto. The pipe members 86 constitute a conventional pipe member capable of carrying a fluid flow. In spite of applying a throttle valve 90 with a slightly different configuration, the operation of the embodiment of FIG. 10 is essentially identical to the operation of the embodiment of FIG. 6.

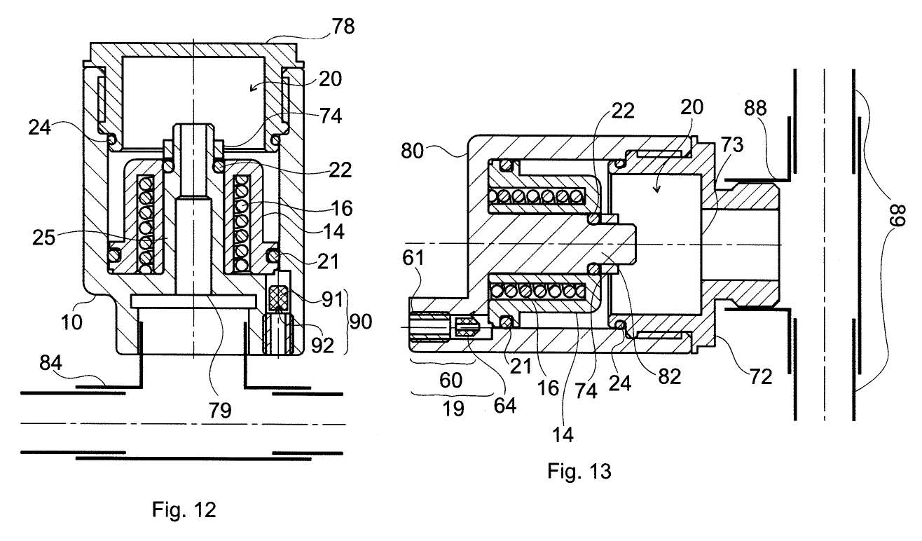

In FIG. 12 a still further embodiment of the device according to the invention is illustrated, which differs from the one illustrated in FIG. 7 in that—as with the embodiment of FIG. 10—a throttle valve 90 is disposed therein. This embodiment is also illustrated connected to a pipe member 84 connecting to a pipe formed by the pipe members 86. As with the embodiment of FIG. 10, the embodiment of FIG. 12 operates in a manner analogous to the operation of the embodiment of FIG. 6.

FIG. 13 illustrates the embodiment of the device according to the invention shown in FIG. 8 connected to the pipe member 88. The pipe member 88 is a T-member and is connected to pipe members 89. The pipe members 89 constitute the vertical branch of a pipe system. In FIG. 13 it is therefore illustrated that the device according to the invention can also be connected to a vertical pipe branch. From the aspect of the operation of the device it is irrelevant that in this embodiment the device is oriented horizontally, fluid—and thus also the shock wave produced in the event of a pressure surge—may enter it through the connection opening 73 in the same way as with the differently oriented embodiments. The operation of the device is therefore identical to the embodiment of FIG. 8.

FIG. 14 illustrates a yet another embodiment of the device for reducing pressure surge according to the invention, comprising a container body 10 and a cap element 12, i.e. it has a dual-connection configuration. In this embodiment, however, a closure element 94 is arranged on the connection member 34, and a seal 96 between the closure element 94 and the connection member 34 (the connection opening 28 is adapted to be closed by the closure element 94 that can be applied particularly together with the seal 96). The closure element 94 is screwed on the connection member 34. Utilizing the closure element 94 the dual-connection container (shown also in FIG. 2) can be converted into a single-connection one. A great advantage of the present embodiment is that by the addition of a few additional components (closure element 94, seal 96) a dual-connection embodiment can be converted into a single-connection one, i.e. applying this embodiment a combined device according to the invention can be provided that can be operated in both single- and dual-connection mode. Dual-connection embodiments can also be converted into single-connection embodiments by replacing the cap element 12, e.g. by including a cap element 78. However, replacing the cap element is much more cumbersome than placing the closure element 94 on the connection member 34. This embodiment operates in a manner analogous to the embodiment of FIG. 7. In an embodiment of the invention therefore a closure element adapted to close the connection opening or the supplementary connection opening is arranged.

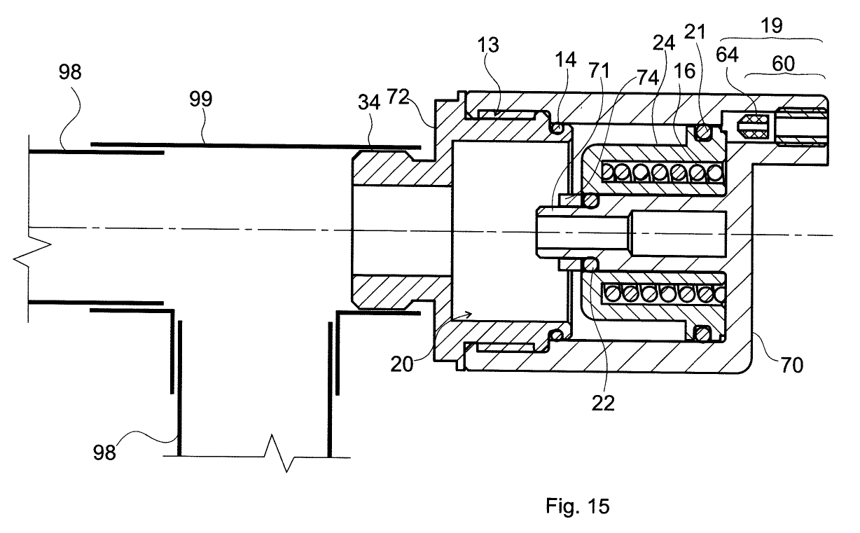

In FIG. 15 a device operated in a manner analogous to the embodiment of FIG. 6 is shown connected to a pipe member 99. The pipe member 99 is a T-member with pipe members 98 being connected therein. This embodiment is essentially installed in a curved pipe section, thereby illustrating the fact that the device according to the invention can be arranged in an arbitrary manner (the device is connected to a leg of the T, thus a curved section is produced by the T-member introduced between the pipe members 98). Unlike the embodiment of FIG. 6, wherein a guiding pin 71 is comprised the embodiment of FIG. 15 comprises a guiding pin 25, the difference between the guiding pins 25 and 71 being in the configuration of their inner cavity.

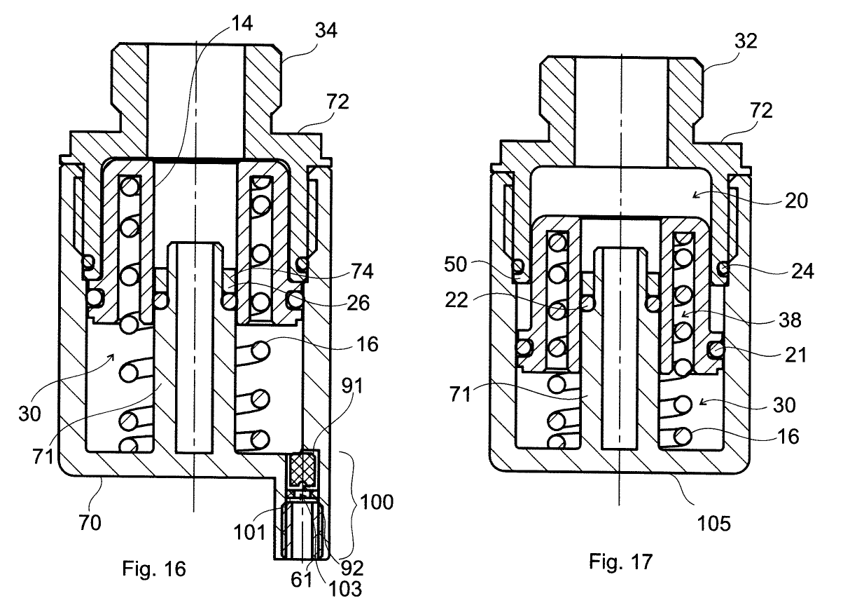

In FIG. 16 a still further embodiment of the invention is illustrated. In this embodiment the device comprises a throttle valve 100. In addition to the moving member 91 and the passage narrowing element 61 the throttle valve 100 also comprises a narrowing ring 101 (reducer ring) being made of resilient material, having a conduction passage 103 having a common axis with the conduction passage 62 of the passage narrowing element 61, and being arranged between the moving member 91 and the passage narrowing element 61. The function of the narrowing ring 101 (O-ring) made of a resilient material (e.g. rubber) is to further narrow down, in an adaptive manner, the passage 92 of the moving member 91 in case gas flowing out from the gas space 30—with the outflowing gas pushing the moving member 91 into the narrowing ring 101—thereby further reducing the rate of gas outflow and increase the resistance provided by the throttle valve 100 in this direction. The flow resistance of the throttle valve 100 against gas inflow is not affected significantly by the arrangement of the narrowing ring 101 if the diameter of the passage 103 is approximately the same as the diameter of the conduction passage 62. The narrowing ring 101 is made of resilient material. The other subcomponents of the throttle valve can be made either of a rigid or a resilient material, with these other subcomponents of the throttle valve being preferably made of a rigid (or less resilient) material if the narrowing ring 101 is resilient.

By allowing for outflow (through a throttle valve, e.g. the throttle valve 60 with a conduction passage 66 or the throttle valve 90 with a passage 92, the throttle valve 100 described above, or throttle valve 141 or 170 to be described later on) in case the volume of the gas space decreases, the invention has the advantage that the fluid potentially having permeated or leaked through the sealing members (even over a long period of time) from the fluid space and having typically evaporated can be discharged from the gas space during the gas outflow, so this amount of vapour does not reduce the volume of the gas space.

The failures (and reduced lifespan) occurring in conventional devices due to minimal sealing defects and to bidirectional diffusion between the fluid space and the gas space can be prevented or eliminated for the sake of a guaranteed long service life. In other words, the desired (envisaged) physical conditions of the chambers (fluid space, gas space) are automatically restored in the long term. The vapour can be discharged from the gas space and the gas space can be replenished continuously, complemented by the physical phenomenon that, due to the high flow resistance of the throttle opening the braking/damping effect of the resilient member is assisted by the compressed gas.

In FIG. 17 an example comprising a closed gas space 30 is illustrated that comprises a container body 105. As described in detail above, in this example the gas space 30 is closed, and thus the displacement of the piston member 14 directed at reducing the volume of the gas space 30 is made more difficult by the gas contained in the gas space. In this example therefore no throttle opening is present, i.e. the gas space is encompassed by a continuous container wall, the wall of the container adapted to delimit the gas space is made to be gas-tight. As detailed above, in this embodiment the gas space 30 preferably comprises low-pressure (e.g. atmospheric-pressure) gas. In this embodiment is not expected to fully contact the bottom of the container body 105 at the maximum-displacement position of the piston member 14 (relative to the base position). The reason for that is that the gas in the gas space 30 has a non-zero volume even in its compressed state.

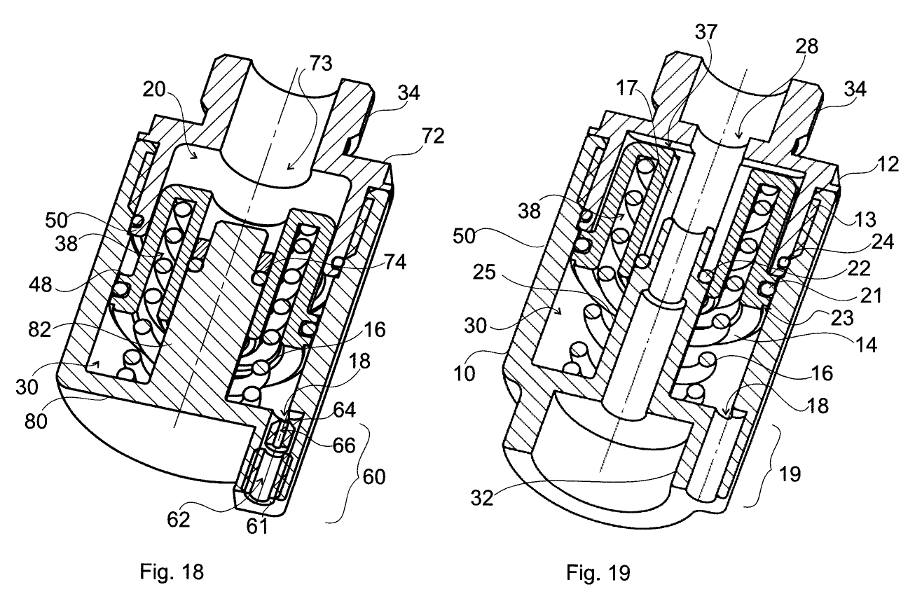

In FIG. 18 the embodiment of FIG. 8 is shown in a spatial sectional drawing (i.e. cut in half). In FIG. 18 the piston member 14 is depicted in an intermediate state between the base position and the maximum displacement. In FIG. 18 the connection opening 73 having a different shape than the shape of the connection opening 28 is shown, and also the subcomponents of the throttle valve 60 are shown: the passage narrowing element 61 having a conduction passage 62 (screwed into the throttle passage 19) and the moving member 64 having a conduction passage 66. It is also illustrated in the figure that the moving member 64 is arranged in a guided manner in the throttle passage 19 (it is not connected directly to the side walls so gas flowing into or out of the gas space can flow around it).

In FIG. 19 an example very similar to FIG. 3 is shown in a spatial sectional drawing (cut in half), the example of FIG. 19 is identical in a number of details with the embodiment of FIG. 1, and as with FIG. 3 it thus may facilitate understanding thereof. In FIG. 19 the subcomponents of the device for reducing pressure surge are clearly shown. In FIG. 19 the device is shown slightly from below, the figure shows a section cutting through two oppositely situated fluid transfer openings 36.

As shown, in this example the piston member 14 is abutted against the cap element 12 in the base position, with an indentation 37 being disposed on the cap element 12. It is clearly shown in the figure that in the base position of the piston member 14 the fluid flowing in the conduction channel (that is made up of inner spaces 54, 56, 58) is able to leave the inner space 58 of the conduction channel through the fluid transfer opening 36 and enter the indentation 37 formed in the cap element 12 and also the region above the piston member 14.

FIG. 19 also clearly shows the circumferential recess 23 arranged on the end portion of the piston member 14 facing the gas space 30, as well as the configuration of the throttle opening 18 and the throttle passage 19. Based on the sectional view it can be observed that the throttle passage 19 is a preferably cylindrical passage, of which essentially the centreline runs to the inside face of the wall bounding the gas space 30 (the throttle passage may also have a different shape, in which case the components of the throttle valve, such as the moving member and the passage narrowing element have to be shaped accordingly). Thanks to this shape and also to the upwards extension along the side wall the throttle opening 18 has the special shape that is shown in FIG. 19.

In the above described embodiments the connection opening is adapted for (capable of) connecting a pipe member capable of carrying a fluid flow such that a connection member, preferably made integrally with the material of the container, was arranged on the connection opening, with the pipe member being adapted to be connected to the connection member, i.e. in the above described embodiments the pipe member is adapted to be connected to the connection opening via a connection member.

In FIG. 20 an embodiment is depicted wherein a connection opening 110 is adapted for connecting a pipe member 107 (T-member) capable of carrying a fluid flow such that the pipe member is made integrally with a cap element 109, i.e. the pipe member 107 is connected to the connection opening 110 such that the pipe member is made integrally with the cap element 109. An Y-member can also be arranged in a manner similar to the pipe member 107 implemented as a T-member. In addition to that, in the present embodiment a plurality of spacer members 112 forming a fluid flow space portion being in fluid communication with the connection opening 110 at any position of the piston member 14 is arranged on the part of the container situated opposite the end portion of the piston member 14 facing the fluid space 20. Such an embodiment can be conceived wherein a single such spacer member (piston spacer) is arranged. When the piston member 14 is abutted against the spacer members 112 (the base position thereof corresponds to this abutted position) the spatial region between the piston member 14 and the wall of the container becomes the fluid flow space part with which the connection opening 110 is in fluid communication via the gap situated between the spacer members 112. If therefore there are arranged multiple spacer members, they are spaced apart from one another (the fact that there are more than one such components, indicates that they are arranged in a disconnected manner), if there is arranged a single such spacer member it is configured such that the fluid communication is maintained between the connection opening and the fluid flow space even in the abutted state of the piston member 14. It may become necessary to include spacer members in the case where without the spacers in its base position the piston member would be seated against the opposing wall of the container. The spacer members may be configured differently from what is illustrated (e.g. they may be formed with knobs); their purpose is to provide that the fluid entering the container can be introduced between the piston member and the wall situated opposite to it such that the fluid can exert pressure on the piston member and can displace it. Otherwise this embodiment is configured a manner similar to the embodiment of FIG. 8 and has an identical operating principle.

In FIG. 21 the embodiment of FIG. 20 is shown in a spatial sectional drawing. In FIG. 21 the stem of the pipe member 107 (implemented as a T-member) leading to the connection opening 110 is observable. Respective connectors are arranged at opposite ends of the pipe member 107.

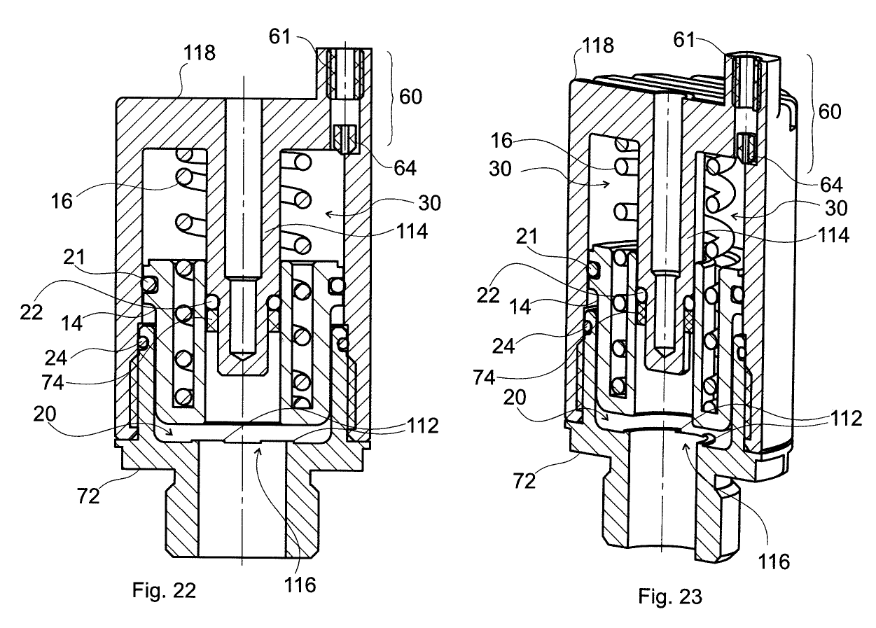

In FIGS. 22 and 23 a yet further embodiment of the invention is illustrated in a sectional and spatial drawing. In this embodiment, too there are spacer members 112 arranged around a connection opening 116. In the embodiment according to FIGS. 22 and 23, a container body 118 of the container further has a guiding pin 114 that has an inner cavity for material savings, but the cavity opens to the outside of the container, not communicating with the fluid space or the gas space. In the embodiments of FIGS. 20-23 the end portion of the container body 118 is provided with rib stiffeners in order to improve the pressure tightness of the container. The container body with the rib stiffeners, as well as the container and certain other components of the device can by way of example be made by injection moulding.

Otherwise this embodiment is configured in a manner similar to the embodiment of FIG. 8 and has an identical operating principle.

One or more spacer member configured identically to the spacer member 112 or spacer members of a different configuration (e.g. radial protrusions), and an indentation similar to the indentation 37 can be arranged also at the end of the piston member that faces the fluid space. By arranging a spacer member or an indentation arranged on the piston member in such a manner, a fluid flow space adapted to be in fluid communication with the connection opening is provided also in this case between the piston member and the container wall.

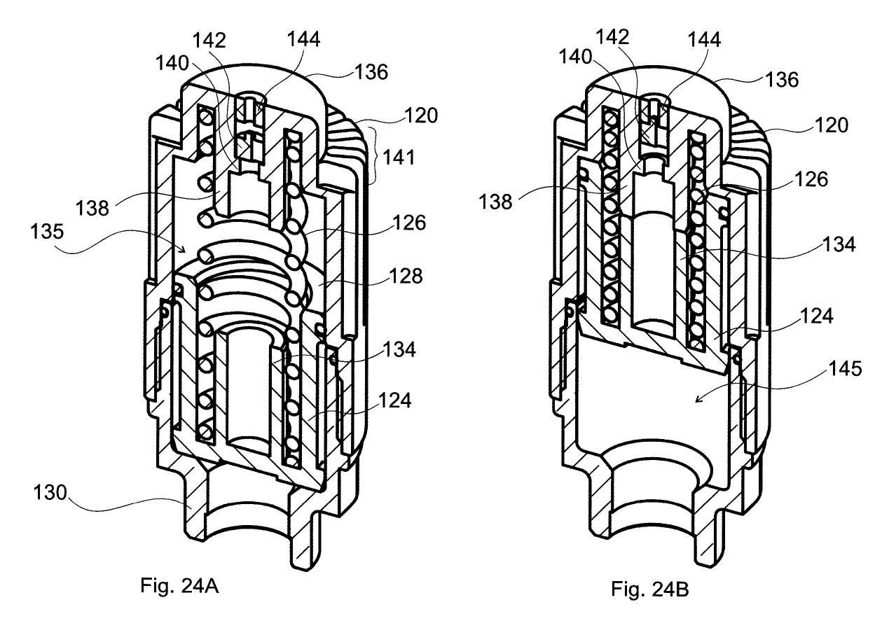

In FIGS. 24A and 24B a further embodiment of the device adapted for reducing pressure surge according to the invention is illustrated. This embodiment is of non-flow through type, i.e. it is connectible to the fluid network (water network) only via a connection member 130. One of the main characteristics of this embodiment is that no component is surrounded by the piston member 124, i.e. the piston member 124 is guided solely by the inside wall of the container body 120 that confines an inner space. Another main characteristic is that a throttle valve 141 (described in detail later on) is arranged on the principal axis of the device. FIG. 24A shows the position of the piston member 124 corresponding to the maximum-volume state of a gas space 135, while FIG. 24B illustrates the position of the piston member 124 corresponding to the maximum-volume state of a fluid space 145 (I.e. in FIGS. 24A, 24B the two terminal positions of the piston member 124 are shown).

In the present embodiment the piston member 124 comprises a receptive opening capable of receiving a spring 126 in the compressed state thereof. In addition to that, further portions of the spring 126 are received in a supplementary receptive opening formed in the side wall of the container body portion 136 that also comprises the throttle valve 141. The spring 126 encompasses a first guiding pin 134 arranged on the piston member 124 and also an oppositely situated second guiding pin 138 arranged on the container body portion 136. As shown in FIG. 24A, in this embodiment in one of its terminal positions the piston member 124 is abutted against one of the end walls of the container body 120. The other terminal position is illustrated in FIG. 24B. In this terminal position the guiding pins 134, 138 are abutted (supported) against each other, with the end of the piston member 124 facing the gas space also abutting against the other terminal wall of the container body 120.

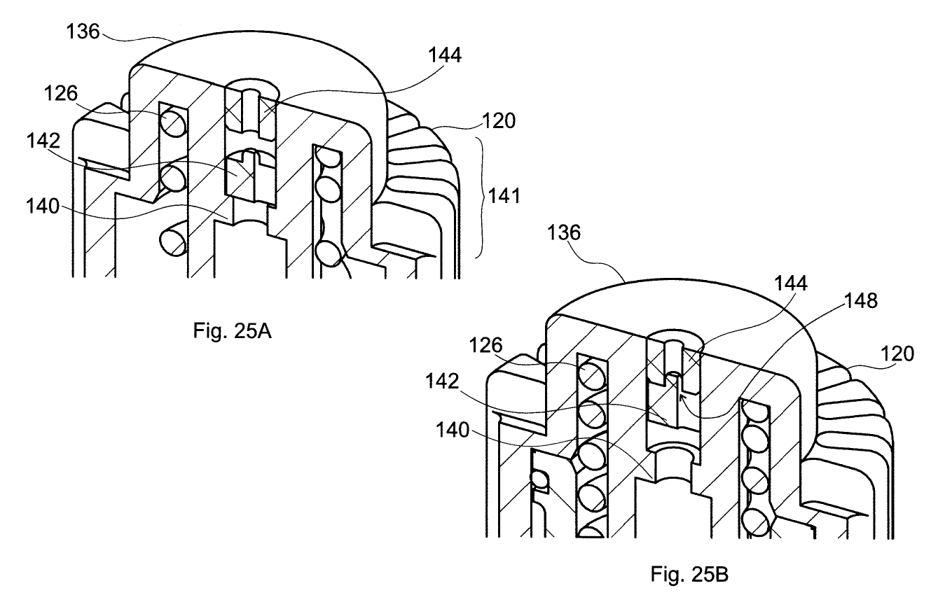

The throttle valve 141 is illustrated in a magnified view in FIGS. 25A and 25B. These figures correspond to a respective detail of FIGS. 24A and 24B (in the corresponding figures the moving member 142 of the throttle valve 141 is in the same status). By comparing FIGS. 24A-25B it can be seen that the throttle valve 141 is in fluid flow connection with the gas space 135 in the event of any displacement of the piston member 124, since it opens from the inner space of the guiding pin 138 that is open towards the end thereof.

According to FIGS. 25A and 25B a throttle passage can be associated also with the throttle valve 141 (the components thereof are arranged along it). On the end portion of the throttle passage opening into the outside space there is arranged a passage narrowing element 144 (that is e.g. screwed into the passage). At the other end of the throttle passage (facing the gas space 135) a passage narrowing element 140 is arranged. It is provided by the passage narrowing elements 140, 144 that a moving member 142 arranged between them cannot leave the throttle passage either in the direction of the gas space 135 or in the direction of the space surrounding the container, i.e. it cannot leave the throttle valve 141.

FIG. 25A illustrates the moving member 142 is in a state corresponding to gas inflow (into the gas space). Under the pressure of the inflowing air in this case the moving member 142 is displaced into the terminal position wherein it is seated on the passage narrowing element 140. In contrast to that, in FIG. 25B the moving member 142 is shown in a position corresponding to a state of gas outflow, wherein it is supported (i.e. is pressed by the outflowing air) on a narrowing arranged at the other end of the passage, i.e. on the passage narrowing element 144.

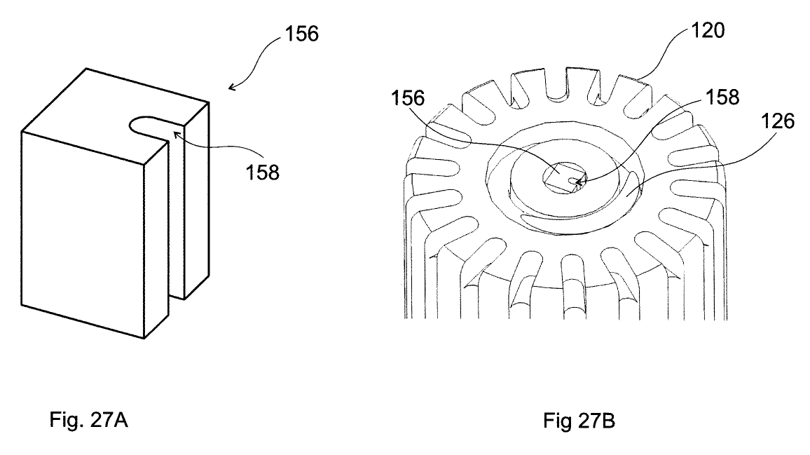

The moving member 142 is shown in FIG. 26A in a magnified spatial drawing. Besides that, a notch 148 thereof is marked also in FIG. 25B and can also be seen in FIG. 25A (in these latter figures the moving member 142 is shown cut in half). The moving member 142 has a basically cylindrical shape. On one of its ends (the one facing the passage narrowing element 144) there is arranged a pin 146. As is illustrated in FIG. 25B, the pin 146 fits into the passage running through the passage narrowing element 144 (towards the outside space surrounding the container). In FIG. 26A there can clearly be seen the configuration of the notch 148, and can be observed that it provides an interconnection between the two ends that extend perpendicular to the longitudinal axis of the cylindrical shape, i.e. on the moving member 142 a notch 148 adapted for interconnecting the first and second end thereof is arranged. The notch 148 and a notch 158 shown in FIG. 27A or another similar notch (in other words: a groove) extends fully along the length of the side of the corresponding moving member (in contrast to the conduction passage 66 of the moving member 64), and thus it is especially well suited for injection molding. The conduction passage of the passage narrowing element 144 is narrower (has a lower diameter) than the conduction passage of the passage narrowing element 140 (the diameter thereof).

The throttle valve 141 operates as follows: In the event of inflow (see FIG. 25A) the moving member 142 is seated on the passage narrowing element 140. As is illustrated in FIG. 25A, air is then able to flow through the notch 148 because the notch 148 is situated partially above the conduction passage of the passage narrowing element 140 (that essentially corresponds to a throttle opening).

In the other terminal position, i.e. in the event of outflow (see FIG. 25B) the pin 146 protrudes into the conduction passage of the passage narrowing element 144, the end of the moving member 142 facing in this direction being abutted against the passage narrowing element 144. Due to this configuration—since the notch protrudes into the pin 146—a flow (outflow) occurs also in this case, and thus air passing through the notch 148 can leave the device through the conduction passage of the passage narrowing element 144.

In order that it can move inside the throttle passage the moving member 142 is of course fitted therein loosely (such that—as shown in the figure—the moving member 142 is guided by the throttle passage) so air can also flow around the moving member 142. In the terminal position corresponding to outflow the moving member 142 is positioned relative to the passage narrowing element 144 by the pin 146; applying the low-diameter pin 146 more accurate positioning can be achieved than by positioning the moving member 142 (having larger cross section) inside the throttle passage, and therefore the outflow resistance can be fine-tuned by disposing an appropriately sized conduction passage on the passage narrowing element 144, and choosing a pin 146 therefor and the depth of the notch 148 appropriately.

In the inflow terminal position no such positioning occurs if a moving member 142 is applied, it is however not required as it is not necessary to accurately adjust the inflow rate (corresponding also to the fact that the inflow rate is preferably much higher than the outflow rate). A higher inflow rate with respect to the outflow rate, i.e. higher gas flow resistance for outflow than for inflow is provided by the configuration according to the figure. As shown in the figure, due to the configuration of the notch 148 and the passage narrowing elements 140, 144 such an outflow cross section is provided that is smaller than the inflow cross section.

FIG. 26B shows a sectional view of FIGS. 25A-25B (the sections cuts the ribs of the container body 120) cutting through the container body 120 in a direction perpendicular to its longitudinal axis and passing through the moving member 142 (accordingly the notch 148 I shown), the spring 136 and the portions of the guiding pin 138 surrounding the moving member 142.

FIG. 27A illustrates a further moving member 156 on which a notch 158 adapted for interconnecting the first and second ends thereof is formed. The moving member 156 has an oblong rectangular block shape. The notch 158 is formed in one of the longer sides thereof. As is illustrated also by FIG. 27B the moving member 156 (dimensioned such that its guiding is provided) can be arranged to replace the moving member 142. Applying a rectangular block-shaped moving member 156 air can flow between the moving member 156 and the throttle passage receiving it at a much higher rate. Because, however, the conduction passage (bore) of the passage narrowing element 144 is narrower than that of the passage narrowing element 140, due to the larger flow cross section a higher inflow rate is produced compared to the outflow rate also with the application of the moving member 156.

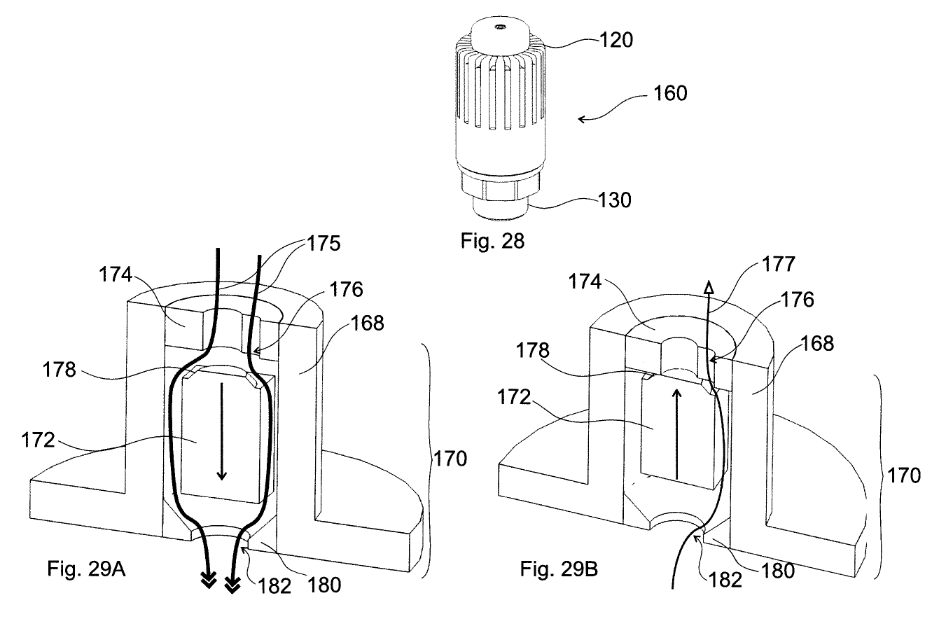

In FIG. 28 a device for reducing pressure surge 160 according to FIGS. 24A-25B is illustrated in a spatial figure. In the figure a container body 120 having a preferably ribbed configuration (this configuration of the container body 120 provides an easy hand grip) and a connection member 130 adapted for connecting the device to the network. are shown

As is illustrated among others also in FIGS. 29A and 29B, to be described below, there is a high degree of freedom in how the throttle valve with a moving member is configured. According to the above, in this embodiment the moving member, the end portion of the throttle passage situated more proximate to the space surrounding the container relative to the moving member, and the second end portion of the throttle passage situated more proximate to the gas space of the container relative to the moving member have to be configured—providing of course that the moving member can travel along the throttle passage between its terminal positions—such that:
the moving member has to be prevented from leaving the throttle passage (condition 1), and
continuous gas flow-through has to be provided during both gas inflow and gas outflow (condition 2).

The above described embodiments disclose a number of exemplary configurations that fulfill these conditions. Condition 1 above can be fulfilled by the appropriate configuration of the specified components. The configuration providing for (ensuring) continuous gas flow-through can be arranged on one of the components or can be provided by at the fitting of adjacent components. If flow asymmetry is provided, it can be sufficient to apply two simple openings and a moving member with a conduction passage. Thus, for example, an opening dimensioned such that the moving member cannot pass through it or a passage narrowing element can be arranged at the end portion of the throttle passage facing the gas space. Based on similar considerations the passage termination and the moving member can also be formed at the other end portion of the throttle passage. To allow for assembling, for example one of the passage narrowing elements can have a screw-in configuration (during manufacturing the moving member is inserted into the throttle passage of the already manufactured container body, followed by “locking” the moving member in the appropriate section of the throttle passage by screwing in the passage narrowing element).

Condition 2 can also be fulfilled in a number of ways (in this embodiment, therefore, by the appropriate configuration of the moving member and the two end portions of the throttle passage). In addition to a continuous gas flow-through it also has to be provided that gas flow resistance is higher in case of gas outflow than it is in case of gas inflow. Above, a number of solutions is illustrated for providing bidirectional gas flow-through (in FIGS. 29A, 29B below a further variant is illustrated), essentially in both terminal positions of the moving member there has to be provided such a passage, notch, conduction passage, etc. (e.g. by configuring the moving member, the passage end portions, or all such components appropriately) through which continuous gas flow can be provided. By dimensioning the passages, notches, and conduction passages appropriately the above specified relation between gas flow resistances can also be provided.

A further throttle valve 170 is illustrated in FIGS. 29A and 29B (the inflow and the outflow state are shown in FIGS. 29A and 29B, respectively). The throttle valve 170 comprises a moving member 172 arranged in a container body portion 168. The moving member 172 has an essentially rectangular block shape with a protrusion 178 being arranged on the end thereof facing the outside space (at the top in the figure).

An opening 182 of the throttle valve 170 opens into the gas space; the opening 182 is configured with a conically narrowing passage narrowing element 180 into which the moving member 172 can be seated to a certain depth. Thanks to the rectangular block-like moving member 172 and to the conically shaped reduction, at the terminal position corresponding to inflow (i.e. when the moving member 172 is seated into the passage narrowing element 180, movement towards the terminal position is illustrated in FIG. 29A by an arrow on the moving member 172) air flowing in from the space surrounding the container can flow through the gaps formed thereby and can flow around the moving member 172, as illustrated in the figure by flow lines 175. In this case, therefore, the existence of a flow path (flow cross section) is provided by configuring the moving member 172 and the passage narrowing element 180 such that they are “tuned” to each other. In this embodiment therefore inflow is preferably provided by that the square-shaped end of the moving member is seated against a conical shape, by which it is essentially impossible to provide perfect closure.

A passage narrowing element 174 is arranged at the end portion of the throttle passage of the throttle valve 170 facing the outside space. A conduction passage is arranged to extend from the throttle passage through the passage narrowing element 174 into the outside space. Furthermore, a notch 176 is formed on this conduction passage (in the sectional drawing shown in the figure this is shown cut in half). As illustrated by an arrow on the moving member 172, in FIG. 29B the moving member 172 assumes its terminal position corresponding to outflow. The conduction passage of the passage narrowing element 174—but not the notch 176—is then covered by the flat top portion of the protrusion 178, allowing air to leave flowing around the protrusion 178 and through the notch 176 as illustrated by a flow line 177 (through a relatively small cross section). The cylindrical shape of the throttle passage—where the rectangular block-shaped moving member 172 can be guided well—is determined by the cylindrical container body portion 168, while it is also possible to fine-tune the outflow and inflow gas flow resistance; it also being possible to tune the extent of blocking by the end portion of the protrusion 178 in case of outflow. It is not necessary to apply the notch along the full length of the passage narrowing element 174, it is sufficient to apply a notch that provides that air passing the moving member is introduced in the conduction passage of the passage narrowing element 174 (e.g., the integrity of the end portion of the conduction passage facing the moving member is impaired, notched at a certain length).

As illustrated also by the flow lines 175 and 177, the inflow rate is higher than the outflow rate, i.e. gas flow resistance is higher during outflow than it is during inflow.

In the device according to the invention the moving member can therefore be implemented as a solid body (with no conduction passage or notch extending along it). In case of gas (air) outflow the moving member is pressed by the outflowing gas, with the end of the moving member facing the passage narrowing element blocking the conduction passage of the passage narrowing element. In this case the outflow of gas has to be sustained in some way (e.g. by forming a notch on the passage narrowing element). When, however, the piston member moves such that it increases the volume of the gas space, i.e. it is approaching its base position, the moving member may be lifted or “pulled off” from the conduction passage of the passage narrowing element by the dropping pressure in the gas space, allowing gas (air) to flow into the space.

In the illustrated embodiments the container comprises a container body and a cap element, confining the inner space of the container, and can be screwed together or can be connected to each other by other means.

The invention is, of course, not limited to the preferred embodiments described in detail above, but further variants, modifications and developments are possible within the scope of protection determined by the claims.

1. A device for reducing pressure surge, comprising
a container having an inner space, the container has a connection opening (28, 73, 79, 110, 116) for connecting a pipe member (84, 88, 99, 107) being suitable for flowing fluid, and
a piston member (14, 124) dividing the inner space of the container into a fluid space (20, 145) being in fluid flow connection with the connection opening (28, 73, 79, 110, 116) and a gas space (30, 135), and being movable along a piston displacement axis,
an elastic element being arranged in the gas space (30,135), being supported against the piston member (14, 124) and undergoing elastic deformation in case the piston member (14, 124) is displaced along the piston displacement axis,
characterised by further comprising a throttle valve (60, 90, 100, 141, 170) being in fluid flow connection with the gas space (30, 135) at any position of the piston member (14, 124), being arranged to connect the gas space (30, 135) and the space surrounding the container, having a first gas flow resistance in case gas flows into the gas space (30, 135) and a second gas flow resistance being larger than the first gas flow resistance in case gas flows out of the gas space (30, 135), and allowing a continuous gas flow in both directions.

2. The device according to claim 1, characterised in that the throttle valve (60, 90, 100, 141, 170) comprises a moving member (64, 91, 142, 156, 172) being arranged in a throttle passage (19) connecting the gas space (30, 135) and the space surrounding the container, being movable between a first end portion and a second end portion of the throttle passage (19), and the moving member (64, 91, 142, 156, 172), the first end portion and the second end portion of the throttle passage (19) is configured to allow the continuous gas flow in both directions.

3. The device according to claim 2, characterised in that the moving member (64, 91, 142, 156, 172) is arranged in a guided manner in the throttle passage (19).

4. The device according to claim 3, characterised in that the throttle valve (30, 60, 100, 141, 170) comprises
a passage narrowing element (61, 144, 174) formed with a conduction passage (62) between the throttle passage (19) and the space surrounding the container, and
the moving member (64, 91, 142, 156, 172) is arranged in the portion of the throttle passage (19) extending from the passage narrowing element (61, 144, 174) towards the gas space (30, 135), and has a second end (65, 95, 178) adapted for at least partially covering the conduction passage (62) of the passage narrowing element (61, 144, 174).

5. The device according to claim 4, characterised in that a conduction passage (66) is formed between a first end (63) and a second end (65) of the moving member (64), or a notch (148, 158) connecting a first end and a second end of the moving member (142, 156) is formed on the moving member (142, 156).

6. The device according to claim 4, characterised in that a passage (92) is formed on the second end (95) of the moving member (91) or at the end of the passage narrowing element (61) facing the second end (95), the passage (92) being adapted for allowing gas flow between the inner space of the throttle passage (19) and the conduction passage (62) of the passage narrowing element (61) in case the conduction passage (62) of the passage narrowing element (61) is covered by the moving member (91).

7. The device according to claim 5, characterised in that a narrowing ring (101) being made of resilient material, having a conduction passage (103) having a common axis with the conduction passage (62) of the passage narrowing element (61) is arranged between the moving member (91) and the passage narrowing element (61).

8. The device according to claim 1, characterised in that
a receptive opening (38) adapted for receiving the elastic element in its compressed state is formed in a first piston end portion of the piston member (14, 124), the first piston end portion facing the gas space (30, 135), and
the first piston end portion being configured such that in a fully compressed state of the elastic element it fits against the wall of the container, and a circumferential recess (23) is formed on the first piston end portion such that, in case the first piston end portion is fitted against the wall of the container, at least a part of a throttle opening (18, 182) of the throttle valve (30, 60, 100, 141, 170) opening into the gas space (30, 135) is covered by a part of the circumferential recess (23).

9. The device according to claim 1, characterised by comprising a conduction channel extending through the container, passing through the piston member (14), connecting the connection opening (28) with a supplementary connection opening (55) and being adapted for flowing a fluid.

10. The device according to claim 9, characterised in that at least one fluid transfer opening (36) connecting the inner space of the conduction channel and the fluid space (20) is formed in the side wall of the conduction channel.

11. The device according to claim 9, characterised in that the supplementary connection opening (55) is adapted for introducing fluid, and between the supplementary connection opening (55) and the connection of the conduction channel to the fluid space the conduction channel comprises a contracted portion with a cross section that is smaller than the cross section at the connection to the fluid space.

12. The device according to claim 9, characterised in that a closure element (94) closing the connection opening (28) or the supplementary connection opening (55) is arranged.

13. The device according to claim 1, characterised in that a stop flange (50) facing the gas space (30) is arranged on the inside of a wall of the container, the piston member (14) comprises
a central piston portion (15) shaped to fit into the opening surrounded by the stop flange (50), and
a piston shoulder portion (48) arranged around the central piston portion (15) and adapted to abut against the stop flange (50).

14. The device according to claim 1, characterised in that an indentation (37) or at least one spacer member (112) forming a fluid flow space portion being in fluid flow connection with the connection opening (28, 110, 116) at any position of the piston member (14) is arranged on the end portion of the piston member (14) facing the fluid space (20, 145) or on the part of the container situated opposite the piston member (14).

15. The device according to claim 1, characterised in that the container comprises a container body (10, 70, 80, 105, 118) and a cap element (12, 72, 78), confining the inner space of the container, and can be screwed together or can be connected to each other by other means.
